(19) United States
(12) Patent Application Publication
(10) Pub. No.: US 2024/0386078 A1
(43) Pub. Date: Nov. 21, 2024

(54) DYNAMIC COLLABORATIVE CONTRACT GENERATORS AND PORTFOLIO MANAGEMENT SYSTEMS

(71) Applicant: NVOKO, LLC, LAKE WORTH, FL (US)

(72) Inventors: Derek Ruffner, Lake Worth, FL (US); Thomas Julia, LAKE WORTH, FL (US); Charlotte Towne, Dania Beach, FL (US)

(21) Appl. No.: 18/668,222

(22) Filed: May 19, 2024

Related U.S. Application Data
(60) Provisional application No. 63/503,333, filed on May 19, 2023.

(51) Int. Cl. G06F 21/10

(52) U.S. Cl. CPC G06F 21/105; G06F 21/108

(57) ABSTRACT

Management systems for music rights and contract generation are described. The contract generation device includes processing circuitry configured to request and/or receive onboarding information from multiple users, the users being, for example, an artist and/or a company, such as a record label. The processing circuitry is further configured to determine, based on the onboarding information and other data, such as parsed responses to a dynamic chatbot and the users' roles and associations with other parties to the contract, a deal scope for a dynamically generated draft contract for the users. The processing circuitry is further configured to dynamically render the draft contract for the users based on the deal scope. The management system and contract generation devices uses song graph modules for machine learning, processing, recording and negotiating rights.

### REFERENCE TO RELATED APPLICATIONS

This patent application claims the benefit under 35 U.S.C. § 119(e) of U.S. Provisional Patent Application No. 63/503,333 filed May 19, 2023 and titled DYNAMIC COLLABORATIVE CONTRACT GENERATOR, which is incorporated herein by reference in its entirety.

### TECHNICAL FIELD

The present disclosure relates to dynamic, collaborative contract generation in a computer system along with corresponding data structures, processes, methods, graphs and displays.

### DESCRIPTION OF THE RELATED ART

Systems that perform contract generation may use a variety of techniques. For example, contract generation may be rules-based, where a predefined set of rules and templates may be used to generate contracts based on user inputs. Such systems may rely on decision trees, conditional logic, and other rule-based algorithms to create custom contract documents. However, existing systems in certain industries lack suitable configurations for dynamically generating contracts when the rules, factors and variables are complex and interdependent, for example, music industry royalty contracts.

### BRIEF DESCRIPTION OF DRAWINGS

A more complete understanding of the present disclosure, and the attendant advantages and features thereof, may be more readily understood by reference to the following detailed description when considered in conjunction with the accompanying drawings wherein:

FIG. 1 is a schematic diagram of an example system according to various embodiments of the present disclosure;

FIG. 2 is a block diagram of an example contract generator device according to various embodiments of the present disclosure;

FIG. 3 is a flowchart of an example process implemented by a contract generator device according to some embodiments of the present disclosure; and

FIG. 4A and FIG. 4B show an example process performed by various components of the system according to some embodiments of the present disclosure;

FIG. 5 shows another example process performed by various components of the system according to some embodiments of the present disclosure;

FIG. 6 shows another example process performed by various components of the system according to some embodiments of the present disclosure;

FIG. 7 shows another example process performed by various components of the system according to some embodiments of the present disclosure;

FIG. 8A and FIG. 8B shows another example process performed by various components of the system according to some embodiments of the present disclosure;

FIG. 9 shows another example process performed by various components of the system according to some embodiments of the present disclosure;

FIG. 10A and FIG. 10B show another example process performed by various components of the system according to some embodiments of the present disclosure;

FIG. 11 shows another example process performed by various components of the system according to some embodiments of the present disclosure;

FIG. 12 shows another example process performed by various components of the system according to some embodiments of the present disclosure; and

FIG. 13 shows another example process performed by various components of the system according to some embodiments of the present disclosure.

FIG. 14 shows a song graph and the inter-relationship between FIGS. 14a-14h.

FIG. 14a is a portion of the song graph shown in FIG. 14.

FIG. 14b is a portion of the song graph shown in FIG. 14.

FIG. 14c is a portion of the song graph shown in FIG. 14.

FIG. 14d is a portion of the song graph shown in FIG. 14.

FIG. 14e is a portion of the song graph shown in FIG. 14.

FIG. 14f is a portion of the song graph shown in FIG. 14.

FIG. 14g is a portion of the song graph shown in FIG. 14.

FIG. 14h is a portion of the song graph shown in FIG. 14.

FIG. 15a is a user interface for a collaborator module.

FIG. 15b is a user interface for a collaborator module.

FIG. 16 is a user interface for an artist settings module.

FIG. 17a is a user interface for a song module.

FIG. 17b is a user interface for a create a new deal module.

FIG. 18a is a user interface module.

FIG. 18b is a user interface module.

FIG. 18c is a user interface module.

FIG. 19a is a user interface module.

FIG. 19b is a user interface module.

FIG. 20a is a user interface module.

FIG. 20b is a user interface module.

FIG. 20c is a user interface module.

FIG. 21 is a user interface module.

### DETAILED DESCRIPTION

The present disclosure relates to computer systems for dynamic and collaborative contract generation, rendering, and management along with their corresponding data structures, processes, methods, graphs and displays.

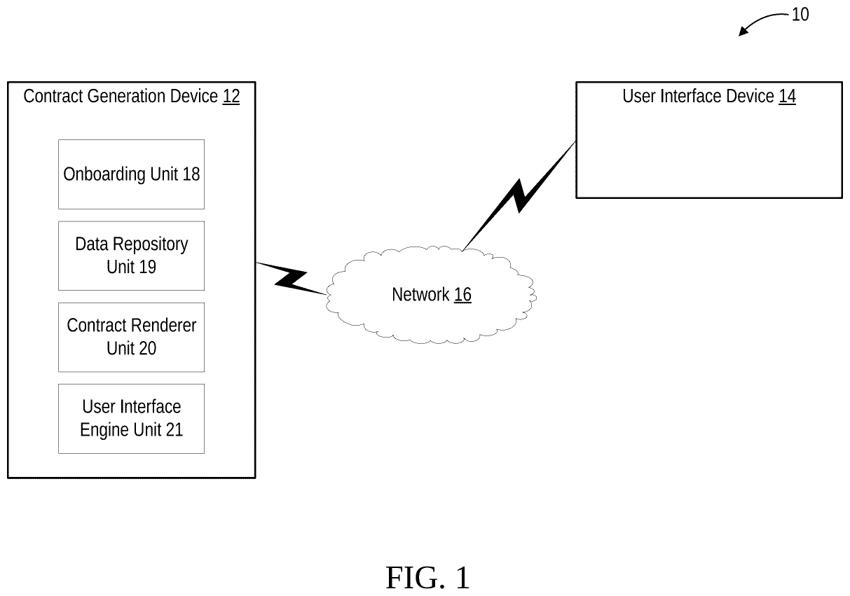

Referring now to the drawing figures in which like reference designators refer to like elements, FIG. 1 is a schematic diagram of a system 10 constructed in accordance with the principles of the present invention. System 10 may include a contract generation device 12 and a user interface device 14. Contract generation device 12 may correspond to and/or may be implemented in a remote server, such as a cloud computing server, or may be co-located with user interface device 14. In one or more embodiments, contract generation device 12 and user interface device 14 may be configured to communicate with each other via one or more communication links and/or protocols. For example, contract generation device 12 may provide user interface 14 with information (visual, text, media, etc.) for displaying/interacting with a user, and may receive responses and/or text and/or other indications from the user.

Further, system 10 may include network 16, which may be configured to provide direct/indirect communication, e.g., wired and/or wireless communication, between any two or more components of system 10, e.g., contract generation device 12, user interface device 14, etc. For example, network 16 may be an internet protocol (IP) network that may be established as a wide area network (WAN) and/or local area network (LAN), among other IP-based networks, etc. Although network 16 is shown as an intermediate network between components/devices of system 10, any component or device may communicate directly with any other component or device of system 10.

Contract generation device 12 may include an onboarding unit 18. Onboarding unit 18 may be implemented by any device, either standalone or part of contract generation device 12, and configurable to perform any step and/or task and/or process and/or method and/or feature described in the present disclosure, e.g., perform one or more contract onboarding, generation, and/or management functions, etc., as described herein. Contract generation device 12 may include a data repository unit 19 configurable to perform any step and/or task and/or process and/or method and/or feature described in the present disclosure, e.g., perform one or more data storage, retrieval, and/or management-related functions for supporting contract generation and/or management, etc., as described herein. Data repository unit 19 may store/retrieve data from a local storage device or component, and/or may interact with external (e.g., cloud-based) data storage. Contract generation device 12 may include a contract renderer unit 20 configurable to perform any step and/or task and/or process and/or method and/or feature described in the present disclosure, e.g., perform one or more rules-based contract generation and/or management functions, etc., as described herein. Contract generation device 12 may include a user interface engine unit 21 configurable to perform any step and/or task and/or process and/or method and/or feature described in the present disclosure, e.g., perform one or more user-interface-related contract generation or management functions, etc., as described herein.

Contract generation device 12 may be implemented in a server, which functionality may be performed by a single server or distributed among multiple servers or computing devices. For example, server functionality, as described herein, may be performed by an on-site or off-site server. Alternatively, server functionality may be performed by several computing devices that may be located in the same general location or different locations, e.g., cloud computing. In other words, each computing device may perform one or more particular sub-processes of server and may communicate with each other via network 16.

User interface device 14 may be any device configured for receiving user inputs and providing/displaying information as outputs to a user. User interface device 14 may be, for example, a smartphone, desktop computer, notebook computer, wearable device, etc., which may receive, e.g., via network 16, user interface display information (e.g., webpage data, mobile application data, etc.) from contract generation device 12 for displaying on a screen of user interface device 14, and may receive (e.g., via keyboard input, voice input, biometric input, etc.) information from the user, e.g., information/instructions/settings/etc. related to contract generation/execution/management/etc. for contract generation device 12, information for authenticating the user, etc.

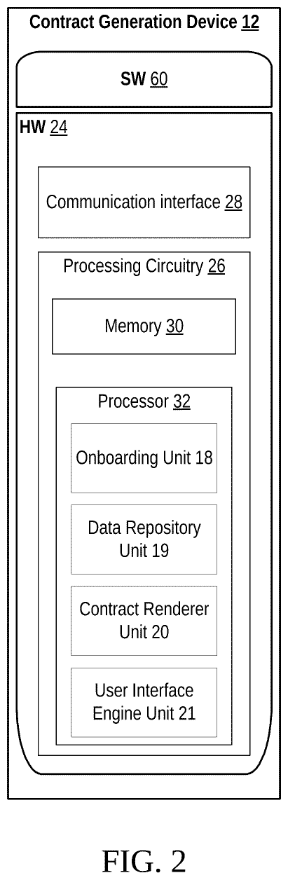

Referring now to FIG. 2, contract generation device 12 may include hardware 24, including processing circuitry 26, and/or communication interface 28. The processing circuitry 26 may include a memory 30 and a processor 32. In addition to, or instead of a processor, such as a central processing unit, and memory, the processing circuitry 26 may comprise integrated circuitry for processing and/or control, e.g., one or more processors and/or processor cores and/or Field Programmable Gate Arrays (FPGAs) and/or Application Specific Integrated Circuits (ASICs) adapted to execute instructions. The processor 32 may be configured to access (e.g., write to and/or read from) the memory 30, which may comprise any kind of volatile and/or nonvolatile memory, e.g., cache and/or buffer memory and/or random access memory (RAM) and/or read-only memory (ROM) and/or optical memory and/or erasable programmable read-only memory (EPROM). Communication interface 28 may comprise and/or be configured to support communication with any components of system 10 or any other component or device using any communication protocol, e.g., via network 16.

Contract generation device 12 may further include software 34 stored internally in, for example, memory 30 or stored in external memory (e.g., database, storage array, network storage device, etc.) accessible by contract generation device 12 via an external connection. The software 34 may be executable by the processing circuitry 26. The processing circuitry 26 may be configured to control any of the methods and/or processes described herein and/or to cause such methods, and/or processes to be performed, e.g., by contract generation device 12. Processor 32 corresponds to one or more processors 32 for performing contract generation device 12 functions described herein. The memory 30 is configured to store data, programmatic software code and/or other information described herein. In some embodiments, the software 34 may include instructions that, when executed by the processor 32 and/or processing circuitry 26, causes the processor 32 and/or processing circuitry 26 to perform the processes described herein with respect to contract generation device 12.

For example, processing circuitry 26 of the contract generation device 12 may include onboarding unit 18 which may be configured to perform one or more contract generation-related actions, request and/or receive one or more contract variables, select one or more contract configurations, request selected, perform analytics using the variables and/or contract configurations, etc.

In some embodiments, the following contract variable types may be defined:

Static Variables: These variables may represent fixed pieces of information, such as whether royalties are calculated retroactively or prospectively, the name of the artist, name of the company/companies or other entities which are party to the contract, etc. Users may input one or more of these variables during the onboarding and/or deal creation process.

Computed Variables: These variables may be calculated/computed based on various types of data. Computed variables may take into account and perform calculations using data from profiles, relationships between profiles, question responses, and other sources. These variables may change from one deal to another, for instance, and/or may be dynamically updated as other data changes.

As another example, processing circuitry 26 of the contract generation device 12 may include a data repository unit 19 configurable to perform any step and/or task and/or process and/or method and/or feature described in the present disclosure, e.g., perform one or more data storage, retrieval, and/or management-related functions for supporting contract generation and/or management, etc., as described herein.

As another example, processing circuitry 26 of the contract generation device 12 may include contract renderer unit 20 configurable to perform any step and/or task and/or process and/or method and/or feature described in the present disclosure, e.g., perform one or more rules-based contract generation and/or management functions, etc., as described herein.

As another example, processing circuitry 26 of the contract generation device 12 may include a user interface engine unit 21 configurable to perform any step and/or task and/or process and/or method and/or feature described in the present disclosure, e.g., perform one or more user-interface-related contract generation or management functions, etc., as described herein.

Communication interface 28 may include at least a radio interface configured to set up and maintain a wireless connection with network 16. The radio interface may be formed as, or may include, for example, one or more radio frequency, RF transmitters, one or more RF receivers, and/or one or more RF transceivers. Communication interface 28 may include a wired communication interface, such as Ethernet, configured to set up and maintain a wired connection with network 16.

Although FIGS. 1 and 2 show various units (e.g., units 18, 19, 20, and 21) as being within a respective processor, it is contemplated that these units may be implemented such that a portion of the unit is stored in a corresponding memory within the processing circuitry. In other words, the units may be implemented in hardware or in a combination of hardware and software within the processing circuitry.

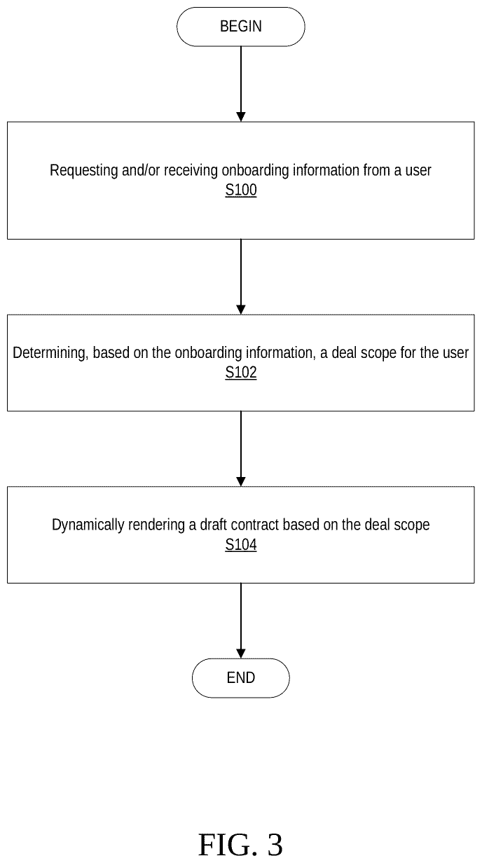

FIG. 3 is a flowchart of an example process (i.e., method) implemented by a contract generation device 12 according to some embodiments of the invention. One or more blocks described herein may be performed by one or more elements of contract generation device 12 such as by one or more of processing circuitry 26, communication interface 28, onboarding unit 18, data repository unit 19, contract renderer unit 20, and/or user interface engine unit 21. Contract generation device 12 is configured to receive and/or request and/or receive (Block S100) onboarding information from a first user and a second user, each of the first and second users being at least one of an artist and a company. Contract generation device 12 is configured to determine (Block S102), based on the onboarding information, a deal scope for the first user and the second user. Contract generation device 12 is configured to dynamically render (Block S104) a draft contract for the first user and the second user based on the deal scope.

In a first set of embodiments and/or use cases, the first user may be an individual and/or independent artist (i.e., not associated with any company), and the second user may also be an individual and/or independent artist (i.e., not associated with any company). In a second set of embodiments and/or use cases, the first user may be an individual and/or independent artist (i.e., not associated with any company), and the second user may be an artist who is associated with a company (e.g., record label, etc.). In a third set of embodiments and/or use cases, the first user may be an artist who is associated with a company (e.g., record label, etc.), and the second user may also be an artist who is associated with a company (e.g., record label, etc.). In the second set of embodiments and/or use cases and the third set of embodiments and/or use cases, one or more companies may be party to the agreement, and there may be an additional (and/or separate) inducement agreement signed between the artist and the company. Thus, in some embodiments and/or use cases, there may not be any company associated with one or more individual users (i.e., parties to the contract), and in some cases, none of the individual users may be associated with any company.

In some embodiments and/or use cases, all onboarding information may be provided by a single user, i.e., the single user may onboard more than one party to an agreement.

In some embodiments, the contract includes a plurality of nodes, each node being dynamically determined based on the deal scope and the onboarding information.

In some embodiments, the deal scope is determined at least in part based on a pre-existing contractual relationship between the first user and the second user.

In some embodiments, the deal scope is determined at least in part based on a pre-existing relationship between the first user and a third-party company not associated with the contract.

In some embodiments, the rendered contract is provided to the first user and the second user for enabling collaborative editing of the contract (e.g., before and/or after the contract has been executed).

For example, when rendering the contract, one or more fields/nodes/variables may be left blank and/or flagged for further user review, as requiring additional information, etc., based on one or more of the inputs of the contract rendering process. A user may propose a revision to a field, node, or other aspect/variable/provision/etc. of a rendered contract, which proposal may be visible to other users (e.g., an artist may be presented with an option to propose revising a royalty term, and the proposal may be visible to another user, such as a record label company, which may be presented with an option to accept, reject, or counter with an alternative proposal).

This collaborative editing functionality allows the contract generation device 12 to streamline the negotiation process by enabling parties to propose, review, and respond to changes in real-time, expediting the contract finalization process and ensuring that all parties reach a mutually satisfactory agreement.

Having described the general process flow of arrangements of the disclosure and having provided examples of hardware and software arrangements for implementing the processes and functions of the disclosure, the sections below provide details and examples of arrangements for performing contract generation.

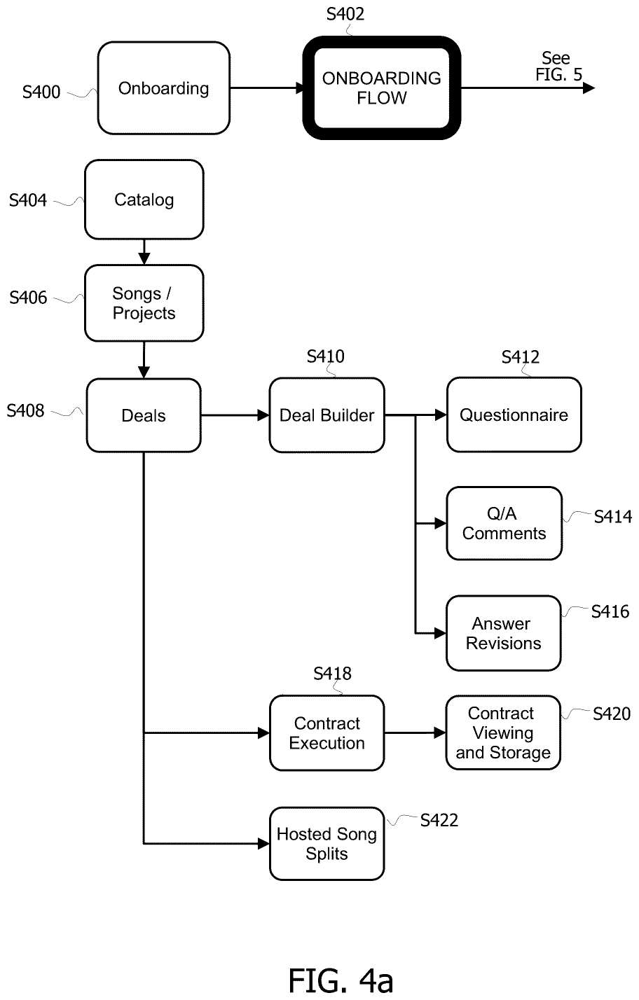

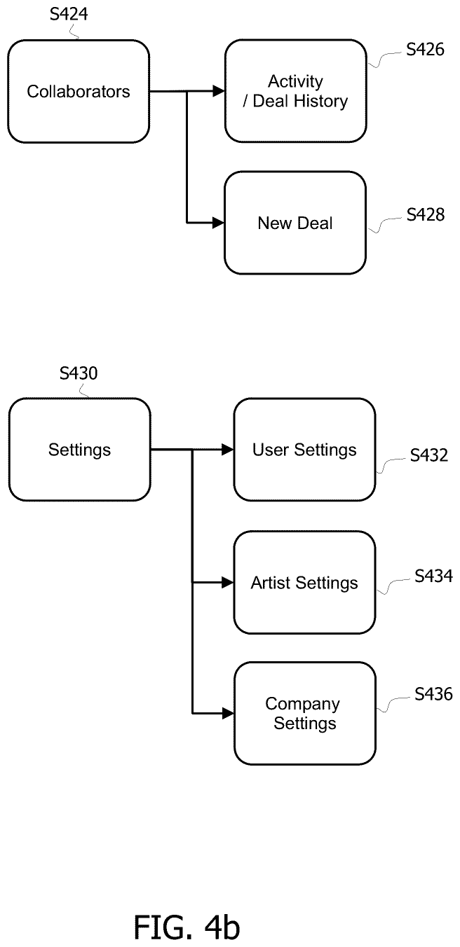

FIG. 4A and FIG. 4B taken together a process flow diagram which illustrates an example embodiment for interfacing with a user of the user interface device 14 and contract generation device 12 for generating, managing, executing, etc. contracts in a music industry context. It is to be understood the music industry context is merely an example implementation, and embodiments of the present disclosure are not limited to this particular implementation, and may be implemented in other contexts, e.g., sports industry contracts, film industry contracts, etc.

In step S400, the system 10, e.g., via contract generation device 12, onboarding unit 18, data repository unit 19, interface engine unit 21, and/or user interface device 14, commences with onboarding the user, wherein the user is registered and authenticated with the system in order to utilize one or more contract generation, management, execution, etc. services. For example, the user interface engine unit 21 may be configured to generate, based on configuration information stored in memory 30 or retrieved from a remote database, a user interface display (e.g., a website, mobile application, etc.), which may appear on user interface device 14.

Step S402 entails proceeding to an onboarding flow, as illustrated and described in FIG. 4A and FIG. 4B, wherein the user is guided (e.g., by contract generation device 12, user interface device 14, onboarding unit 18, etc.) through a series of interactive steps, screens, or interfaces designed to collect and verify necessary information pertaining to the user and the user's contract(s).

The onboarding process may be dynamic, for example, using a chatbot, interactive questionnaire, etc.

The chatbot may begin by determining the user's role, if not already known: “Welcome to our contract generation and review service! Please select your role: Musical Artist, Record Company, or Other (e.g., Attorney).” Other role types (business manager, etc.) may be defined without deviating from the scope of the present disclosure.

Based on the response to the above prompt, or some other basis for determining a user's role, the chatbot/questionnaire may continue with a specially-tailored environment for that role. The following non-limiting examples may apply to a User A (musical artist), User B (record company), and User C (attorney representing a party):

### Example 1

Dynamic Questionnaire/Chatbot Interaction for Initial User Onboarding of User A (Musical Artist)

In this example, User A (the musical artist) interacts with the dynamic questionnaire/chatbot (e.g., implemented by contract generation device 12, user interface device 14, onboarding unit 18, etc.) during the initial onboarding process. The questionnaire/chatbot uses data, metadata, and responses to create a tailored onboarding experience for User A:

1. The chatbot may ask for User A's basic information, such as their name, stage name, genre, and contact information. The chatbot may also dynamically present questions based on User A's responses, such as inquiring about any subgenres based on the selected genre.

2. The chatbot may use metadata from other artists' profiles to suggest popular preferences, such as the desired royalty percentage or advance amount: “Many artists in your genre tend to prefer a royalty rate of [X]%. Would you like to set this as your preferred rate?”

3. The chatbot may ask User A about their preferences and priorities for contract negotiations, such as tour support, merchandise rights, or creative control. Based on User A's responses, the chatbot can show/hide or reword additional questions to gather more detailed information.

4. The chatbot asks User A about their current contractual status, such as whether they have any existing contracts or legal obligations to record companies: “Are you currently signed to a record company or have any existing contracts with record companies?”

5. If User A responds affirmatively, the chatbot may ask for more information about the existing contracts, such as the record company's name, contract duration, and key terms. The chatbot can also inquire if User A requires assistance in managing or reviewing these existing contracts.

6. If User A responds negatively, the chatbot may ask if the artist is independent and whether they are seeking a record company for future contracts: “Are you an independent artist? If so, are you looking for a record company to sign with in the future?”

7. Based on User A's responses, the chatbot can show/hide or reword additional questions to gather more detailed information about their contractual status, preferences, and requirements. This allows the service to better support User A in generating, managing, and reviewing contracts in line with their specific needs.

In some embodiments and scenarios, the user may be an individual artist as well as being represented by (or representing) a company. Thus, in some embodiments and scenarios, the user may be associated with a company.

### Example 2

Dynamic Questionnaire/Chatbot Interaction for Initial User Onboarding of User B (Record Company)

In this example, User B (the record company) interacts with the dynamic questionnaire/chatbot during the initial onboarding process for the contract generation/review service. The questionnaire/chatbot uses data, metadata, and responses to create a tailored onboarding experience for User B.

1. The chatbot may start with a personalized welcome message: “Hello and welcome, record company representative! Let's set up your profile and preferences.”

2. The chatbot may ask for User B's basic information, such as the company name, contact information, genres they work with, and any sub-labels associated with the company. The chatbot may also dynamically present questions based on User B's responses, such as inquiring about the specifics of the sub-labels.

3. The chatbot may use metadata from other record companies' profiles to suggest popular contract terms, such as the average royalty percentage or advance amount offered to artists: “Many record companies in your genre tend to offer a royalty rate of [X]%. Would you like to set this as your standard rate?”

4. The chatbot may ask User B about their preferences and priorities for contract negotiations, such as budget limits for artist advances, tour support policies, or marketing strategies. Based on User B's responses, the chatbot can show/hide or reword additional questions to gather more detailed information.

In some embodiments and scenarios, the user may be an individual artist as well as being represented by (or representing) a company. Thus, in some embodiments and scenarios, the user may be associated with a company.

### Example 3

Dynamic Questionnaire/Chatbot Interaction for Initial User Onboarding of User C (Other, e.g., Attorney)

In this example, User C (e.g., an attorney representing a party) interacts with the dynamic questionnaire/chatbot during the initial onboarding process for the contract generation/review service. The questionnaire/chatbot uses data, metadata, and responses to create a tailored onboarding experience for User C.

1. The chatbot may start with a personalized welcome message: “Hello and welcome, legal professional! Let's get started with creating your profile and setting up your client preferences.”

2. The chatbot may ask for User C's basic information, such as their name, contact information, and the type of clients they represent (e.g., musical artists, record companies, or both).

3. The chatbot may use metadata from other legal professionals' profiles to suggest popular preferences or contract terms they may want to consider for their clients. The chatbot can also inquire about User C's priorities for contract negotiations, such as royalty rates, advances, or other specific clauses.

4. Based on User C's responses, the chatbot can show/hide or reword additional questions to gather more detailed information about their clients' preferences and requirements, allowing the service to better assist User C in generating and reviewing contracts on behalf of their clients.

These examples demonstrate how the dynamic questionnaire/chatbot interactions facilitate the initial user onboarding process for various user types, including musical artists, record companies, and other professionals like attorneys, agents, business managers, financers, etc. This personalized onboarding experience allows the service to provide more accurate and effective contract generation and review processes tailored to each user's role and preferences.

Step S404 includes the retrieval (e.g., via data repository unit 19) and display (e.g., via contract generation device 12, user interface device 14, etc.) of the user's catalogs, wherein the user's collection of music, albums, and other creative works are organized, managed, and presented for ease of access and review.

In step S406 includes the retrieval and/or display (e.g., by contract generation device 12, user interface device 14, etc.) of the user's songs and projects, providing the user with a comprehensive overview of their musical creations, collaborative efforts, and ongoing projects.

In step S408, the system 10 retrieves and displays the user's deals, where the user's existing contractual arrangements, negotiations, and pending agreements are presented for review and management.

Step S410 entails the retrieval and display (e.g., by contract generation device 12, user interface device 14, etc.) of a deal builder interface, wherein the user is provided with a graphical, interactive platform that allows the user to create, modify, and finalize the terms and conditions of a music-industry related contract.

In step S412, the system 10 provides (by contract generation device 12, user interface device 14, etc.) a questionnaire or chatbot interaction to the user, wherein a series of questions (e.g., natural language questions) is presented to gather pertinent information related to the specific contract(s) being generated/managed/executed/etc., thereby providing accuracy and comprehensiveness to the contract generation/management/execution processes.

A questionnaire, chatbot, etc. for onboarding and/or for contract generation/revision, according to embodiments of the present disclosure, may be dynamic. For example, the contract generation device 12 and/or user interface device 14 may be configured to reword/show/hide questions during the questionnaire process based off of previous answers and deal context. For example, rewording may correspond to referring to the artist by name, by pulling this information from the artist profile, during a chatbot interaction, etc.

The following non-limiting examples describe a chatbot/questionnaire process for contract generation/renewal/management/etc. for User A (musical artist) and User B (record company representative):

### Example 4

Dynamic Questionnaire/Chatbot Interaction for User A (Musical Artist) during Contract Generation/Revision Process

In this example, User A (the musical artist) interacts with the dynamic questionnaire/chatbot during the contract generation/revision process involving a music royalties contract. The questionnaire/chatbot uses data, metadata, and responses to create a tailored experience for User A.

1. The chatbot starts with a personalized message: “Hello [Artist Name]! We are now generating a music royalties contract between you and [Record Company Name]. Let's gather some information to tailor the contract to your preferences.”

2. The chatbot may ask User A about their desired royalty percentage and advance amount, and compare it with the record company's standard rates to identify any discrepancies that may need to be negotiated.

3. The chatbot may inquire about other contract clauses relevant to the artist, such as creative control, tour support, and merchandise rights. Based on User A's responses, the chatbot can show/hide or reword additional questions to gather more detailed information.

4. The chatbot may present a summary of User A's preferences and ask if they would like to revise any of the terms before submitting them to User B (the record company representative) for negotiation.

5. Once User A confirms their preferences, the chatbot notifies User B of the proposed contract terms and initiates the negotiation process.

### Example 5

Dynamic Questionnaire/Chatbot Interaction for User B (Record Company Representative) during Contract Generation/Revision Process

In this example, User B (the record company representative) interacts with the dynamic questionnaire/chatbot during the contract generation/revision process involving a music royalties contract. The questionnaire/chatbot uses data, metadata, and responses to create a tailored experience for User B.

1. The chatbot starts with a personalized message: “Hello [Representative Name]! We are now generating a music royalties contract between [Artist Name] and your company, [Record Company Name]. Let's review the proposed terms from the artist.”

2. The chatbot presents the terms proposed by User A (the musical artist), such as the desired royalty percentage, advance amount, creative control, tour support, and merchandise rights.

3. The chatbot may ask User B if they agree with the proposed terms or would like to counter with alternative terms. Based on User B's responses, the chatbot can show/hide or reword additional questions to gather more detailed information about their counter-proposals.

4. If User B agrees with the proposed terms, the chatbot proceeds to finalize the contract. If User B counters with alternative terms, the chatbot notifies User A of the counter-proposals and initiates further negotiation.

5. The chatbot guides both User A and User B through the negotiation process, dynamically adapting the questions and information presented based on their responses, until an agreement is reached and the contract is finalized.

Step S414 includes providing/retrieving (e.g., by contract generation device 12, user interface device 14, etc.) question and answer (collaborative) comments for the contract(s), wherein the system 10 enables the user to input, receive, and/or review comments or clarifications regarding the questions and answers regarding the contracts, facilitating improved communication and understanding among involved parties. In some embodiments, there may be other types of users in addition to musical artists or record company representatives, such as attorneys, business managers, assistants, etc., who may be granted access privileges to review terms, for example, but may, in some cases, be restricted in one or more aspects of the contract generation/revision/management/execution process. For example, an attorney or business manager type user may be able to comment on terms, but may be restricted from modifying (and/or proposing modification of) the terms, in some cases. For example, in some embodiments, a first category of users may be able to view and change terms, a second category of users may only be able to view terms, a third category of users may be able to view terms and add comments, but not propose changes, etc.

In step S416, the system 10 (e.g., via contract generation device 12, user interface device 14, etc.) provides collaborative answer revisions, allowing the user to edit, update, or modify any previously provided answers in order to refine the contract details and ensure all information is accurate and current.

Step S418 encompasses contract execution (e.g., by contract generation device 12, user interface device 14, etc.), wherein the finalized contract is executed by the appropriate parties through digital signatures, secure authentication methods, or other legally binding means.

In step S420, the system 10 enables contract viewing and storage (e.g., by contract generation device 12, user interface device 14, etc.), providing the user with a secure platform to access, review, and store the executed contract for future reference and recordkeeping purposes.

Step S422 involves the retrieval and display (e.g., by contract generation device 12, user interface device 14, etc.) of hosted song splits, wherein the system presents the agreed-upon division of ownership, royalties, or other financial arrangements between the involved parties in relation to the specific song or project associated with the generated contract.

In step S424, the system 10 enables the retrieval and displays (e.g., by contract generation device 12, user interface device 14, etc.) of collaborators, such as song collaborators, who are involved in the music project or contract. This step facilitates the identification and management of individuals or entities contributing to the creative work in question.

Step S426 involves the retrieval and display (e.g., by contract generation device 12, user interface device 14, etc.) of activity and/or deal history, providing the user with a comprehensive overview of their past interactions, negotiations, and agreements within the system. This information may prove valuable for decision-making or future contract negotiations.

Step S428 involves retrieval and display (e.g., by contract generation device 12, user interface device 14, etc.) of a new deal creation form or process, enabling the user to initiate the generation of a new contract by inputting relevant information and selecting the desired terms and conditions, for example.

Step S430 entails the retrieval and display (e.g., by contract generation device 12, user interface device 14, etc.) of system settings, where the user can access and modify general system preferences, configurations, or options to tailor their experience within the platform to their specific needs, for example.

Step S432 involves retrieval and display (e.g., by contract generation device 12, user interface device 14, etc.) of user settings, providing the user with a dedicated interface to manage and configure their individual account settings, preferences, and personal information within the platform.

Step S434 involves the retrieval and display (e.g., by contract generation device 12, user interface device 14, etc.) of artist settings, offering the user an interface to manage and configure settings specific to the artist or creative persona associated with the contract or music project. This may include information related to the artist's brand, social media presence, or promotional strategies, for example.

Step S436 includes retrieval and display (e.g., by contract generation device 12, user interface device 14, etc.) of company settings, enabling the user to access and manage settings and information specific to the company or organization associated with a contract or with a user, such as contact details, legal representation, or business structure. This step ensures that the company's interests and requirements are adequately addressed within the context of contract generation, management, execution, etc.

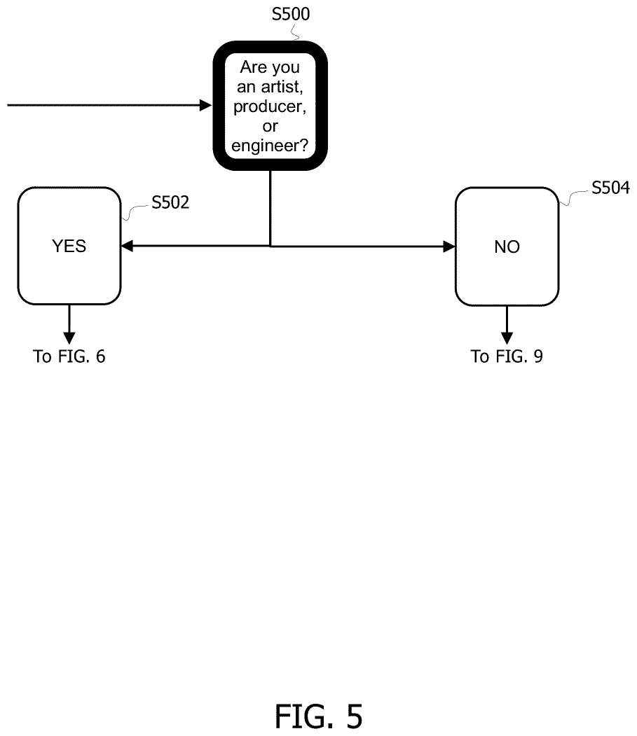

FIG. 5 is a process flow diagram which illustrates an example embodiment for further onboarding a user of the user interface device 14 and contract generation device 12 for generating, managing, executing, etc. contracts in a music industry context (as an example context).

In step S500, contract generation device 12, in conjunction with user interface device 14 (and/or onboarding unit 18, user interface engine unit 21, etc.), asks the user if they are an artist, producer, or engineer, seeking to identify the user's role within the music industry. The request may be via, e.g., a chatbot, a dialog box, etc.

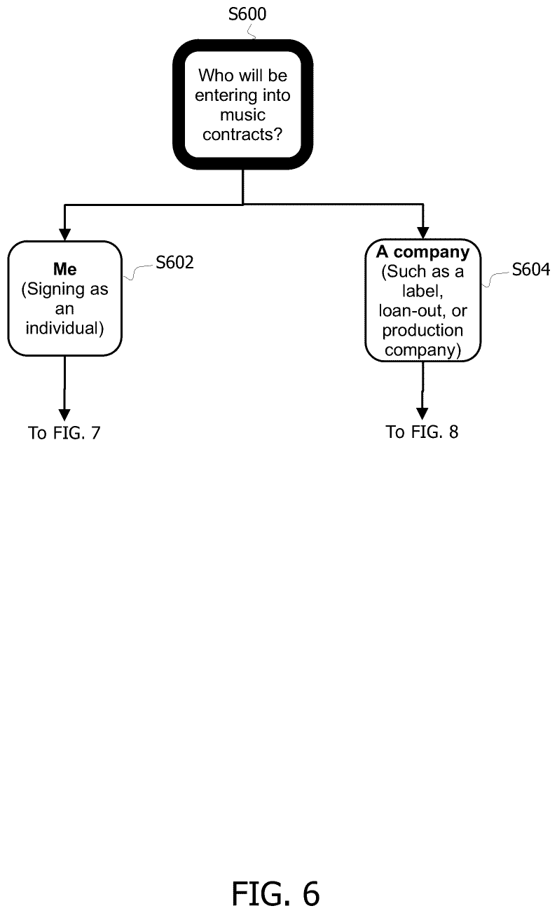

Step S502 involves the user responding ‘yes’ (or providing an equivalent acknowledgment input, such as a button click, a verbal response, a text based or natural language response, etc.) to step S500, upon which the system, e.g., via contract generation device 12, proceeds to the flow illustrated in FIG. 6.

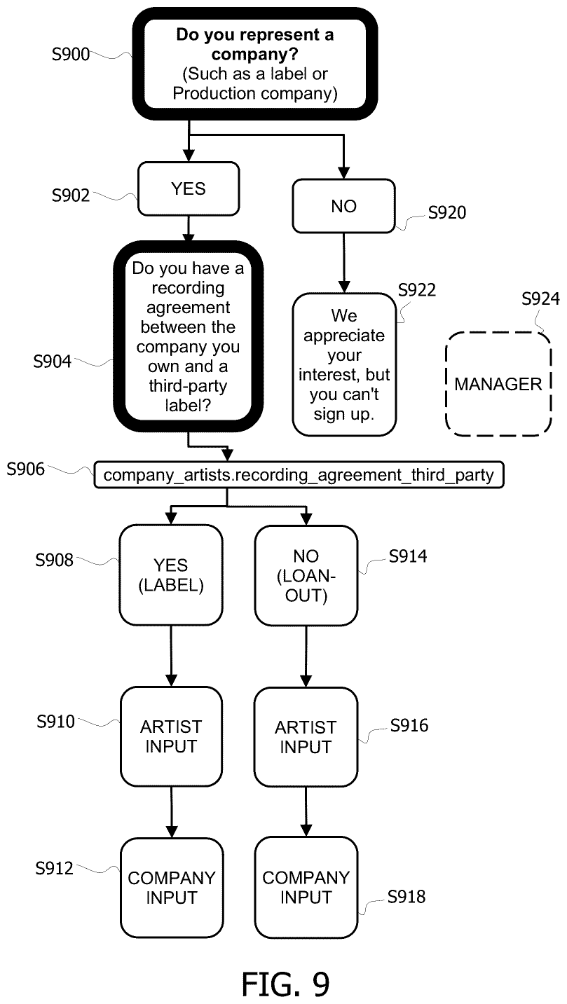

In step S504, if the user responds ‘no’ to step S500, contract generation device 12 directs the flow to proceed to FIG. 9.

FIG. 6 is a process flow diagram which illustrates an example embodiment for onboarding a user of the user interface device 14 and contract generation device 12 for generating, managing, executing, etc. contracts in a music industry context (as an example context). The onboarding may be performed, e.g., by one or more of onboarding unit 18, data repository unit 19, and user interface engine unit 21, for example.

Step S600, performed by contract generation device 12 and user interface device 14, involves asking the user who will be entering into the music contract(s), seeking to determine the parties or entities responsible for contractual obligations.

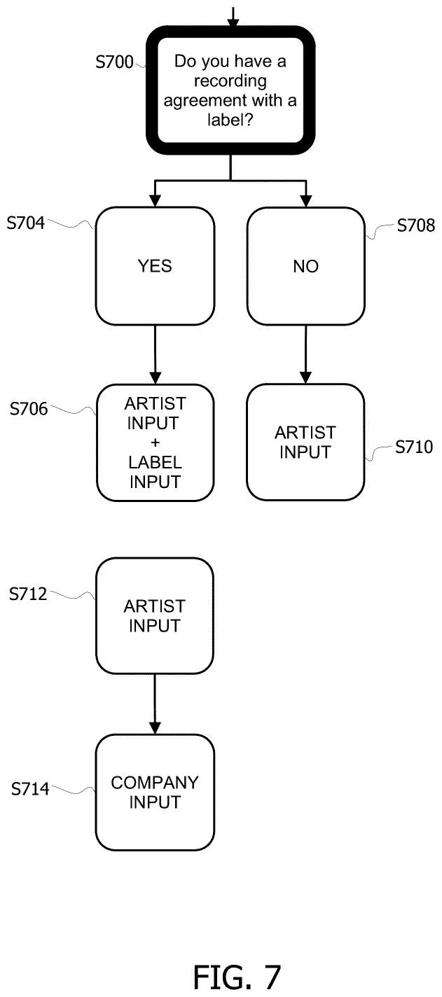

In step S602, if the user responds to step S600 with “me” or an equivalent response indicating that the user himself or herself will be personally entering into the contract being generated, contract generation device 12 directs the flow to proceed to FIG. 7.

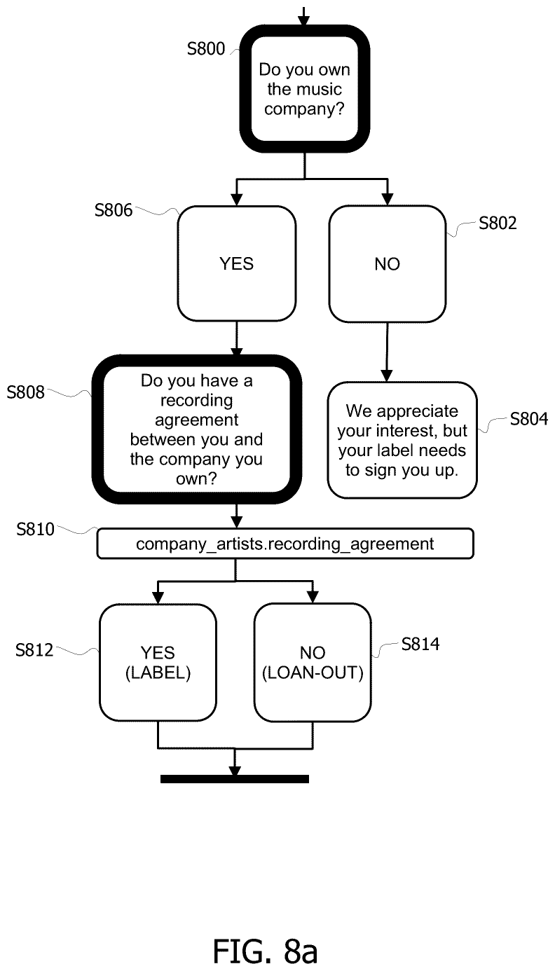

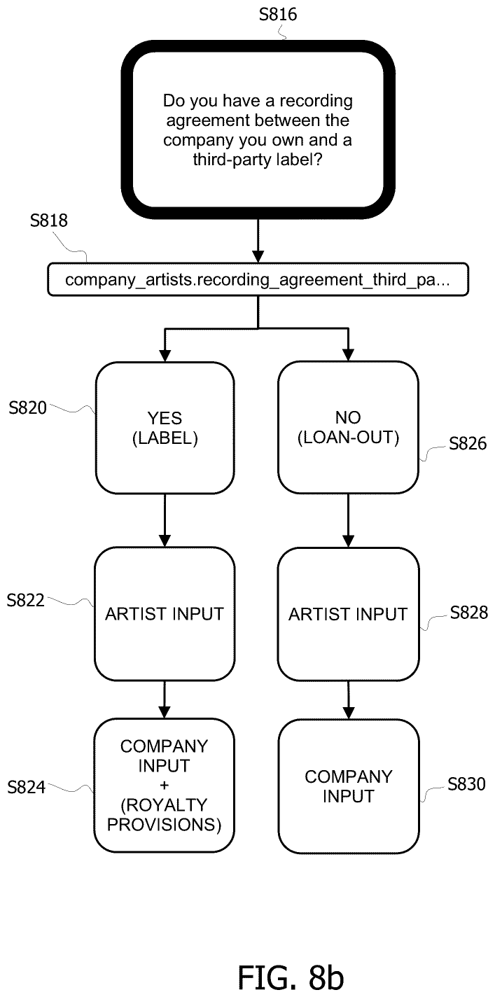

In step S604 if the user responded to step S600 with “a company” or equivalent response, such as a label, loan-out, or production company, then contract generation device 12 directs the flow to proceed to FIG. 8.

FIG. 7 is a process flow diagram which illustrates an example embodiment for onboarding a user of the user interface device 14 and contract generation device 12 for generating, managing, executing, etc. contracts in a music industry context (as an example context).

In step S700, contract generation device 12, in conjunction with user interface device 14, asks the user if the user has a recording agreement with a label, aiming to identify any existing contractual relationships that may impact the user's ability to enter into new contracts.

Step S702 occurs when the user responds ‘yes’ to step S700, and contract generation device 12 directs the flow to proceed to step S706.

In step S706, contract generation device 12, in conjunction with user interface device 14, notifies the user that the user cannot sign up through the portal, and instead, the label must sign up for the user, ensuring compliance with existing contractual agreements.

Step S708 is triggered when the user responds “no” (or with an equivalent response) to step S700, at which point contract generation device 12 directs the flow to proceed to step S710.

In step S710, contract generation device 12 and user interface device 14 work together to obtain artist input information needed to begin generating the contract, collecting relevant data to ensure the resulting contract is accurate, comprehensive, and tailored to the user's specific requirements.

In some embodiments, following step S706, the process flow proceeds to step S712, which includes, optionally, receiving artist input and company input (step S714), which may enable or facilitate contract generation/management/execution.

In some embodiments, if, during an onboarding process or contract generation/revision process, it is determined (e.g., via the chatbot/questionnaire/etc. interaction with a user) that the user is a musical artist who is currently represented by a label (record company), the contract generation device 12 may be configured to connect the artist's profile with the profile of the label. In some embodiments, the artist may need to search for (e.g., via user interface device 14 and data repository unit 19, for example) or create the label's profile, if it does not already exist in the system, e.g., according to the following non-limiting example.

### Example 6

Dynamic Questionnaire/Chatbot Interaction for User A (Musical Artist) during Onboarding or Contract Generation/Revision Process with Label Connection

In this example, User A (the musical artist) interacts with the dynamic questionnaire/chatbot during the onboarding or contract generation/revision process. The questionnaire/chatbot uses data, metadata, and responses to determine that User A is represented by a record company and connects the artist's profile with the label's profile.

During the onboarding process or contract generation/revision process, the chatbot asks User A about their current contractual status: “Are you currently signed to a record company or have any existing contracts with record companies?”

1. User A responds affirmatively, indicating that they are represented by a label.

2. The chatbot proceeds to gather more information: “Please provide the name of the record company you are currently signed with.”

3. User A provides the name of their record company, which the chatbot uses to search the data repository unit 19 for the label's profile.

4. If the label's profile is found, the chatbot connects User A's profile with the label's profile: “Great! We found [Record Company Name] in our system. Your profile has been successfully connected to your record company's profile.”

5. If the label's profile is not found, the chatbot prompts User A to create the label's profile: “We couldn't find [Record Company Name] in our system. Would you like to create a new profile for your record company? This will help us to better manage your contracts and facilitate communication between you and your label.”

6. If User A agrees to create the label's profile, the chatbot guides them through the process of providing necessary information, such as the record company's name, contact information, and key representatives.

7. Once the new profile is created, the chatbot connects User A's profile with the newly created label's profile: “Your profile has been successfully connected to your record company's profile. This will help streamline the contract generation and revision process.”

FIG. 8 is a process flow diagram which illustrates an example embodiment for further onboarding a user of the user interface device 14 and contract generation device 12 for generating, managing, executing, etc. contracts in a music industry context (as an example context).

In step S800, if the user responded “a company” to step S604 described above, the flow proceeds to S800, where contract generation device 12 and user interface device 14 ask the user if they own the music company at issue.

Step S802 is triggered if the user responds “no” (or equivalent) to step S800, and contract generation device 12 directs the process flow to proceed to step S804.

In step S804, contract generation device 12 and user interface device 14 inform the user that the company, not the user, must perform the onboarding process, ensuring the proper entity is responsible for the onboarding.

Step S806 occurs when the user responds “yes” (or equivalent) to step S800, at which point contract generation device 12 directs the flow to proceed to step S808.

In step S808, contract generation device 12 and user interface device 14 ask the user if there is a recording agreement between the user and the company that the user owns.

Step S810, alternatively or in addition to retrieving information from the user in Step S808, involves searching (using data repository unit 19 of contract generation device 12, for instance) and retrieving and/or updating a list of recording agreements associated with the company and/or the user.

In step S812, if the answer to S808 is “Yes” (or equivalent), contract generation device 12 and user interface device 14 classify the company as a “label” type company and proceed to step S816.

Step S814 occurs when the answer to S808 is “no” (or equivalent), and contract generation device 12 and user interface device 14 classify the company as a “loan-out” type company, proceeding to step S816.

In step S816, contract generation device 12 and user interface device 14 ask the user if there is a recording agreement between the company the user owns and any third-party labels.

Step S818, similar to Step S810, alternatively or in addition to retrieving information from the user in Step S816, involves searching (using data repository unit 19 of contract generation device 12, for instance) and retrieving and/or updating a list of recording agreements associated with the company and any third-party labels.

In step S820, if the answer to Step S816 is “yes” (or equivalent), contract generation device 12 and user interface device 14 characterize the company as a “label” type company and proceed to Step S822 and Step S824.

Step S822 involves requesting and receiving artist information input from the user (e.g., via a chatbot, form entry window, etc.) and storing it with data repository unit 19.

In step S824, contract generation device 12 and user interface device 14 receive company information and royalty provisions input from the user and store it with data repository unit 19.

Step S826 is triggered when the answer to step S816 is “no” (or equivalent), and contract generation device 12 and user interface device 14 characterize the company as “loan-out” and proceed to step S828 and step S830.

In step S828, contract generation device 12 and user interface device 14 receive artist information input from the user and store it with data repository unit 19.

In step S830, contract generation device 12 and user interface device 14 receive company information from the user and store it with data repository unit 19.

FIG. 9 is a process flow diagram which illustrates an example embodiment for onboarding a user of the user interface device 14 and contract generation device 12 for generating, managing, executing, etc. contracts in a music industry context (as an example context).

In step S900, the process flow proceeds to step S900 when the user responds “No” (or equivalent) in step S504. In step S900, contract generation device 12 and user interface device 14 ask the user whether they represent a company such as a label or production company.

Step S902 occurs when the user responds “yes” (or equivalent) to S900, and contract generation device 12 directs the flow to proceed to Step S904.

In step S904, contract generation device 12 and user interface device 14 ask the user if there is a recording agreement between the company the user owns and a third-party label.

Step S906, alternatively or in addition to step S904, involves data repository unit 19 searching to find any third-party recording agreements with the company.

In step S908, based on the user response in S904 (and/or the result of searching in step S906), it is confirmed that there is a recording agreement between the company the user owns and a third-party label. Contract generation device 12 and user interface device 14 characterize the company as a “label” type company, and the process flow proceeds to step S910 and step S912.

Step S910 involves collecting artist information input from the user and storing it in data repository unit 19 in association with the artist, company, contract, etc.

In step S912, contract generation device 12 and user interface device 14 collect the company information input from the user and store it in data repository unit 19.

Step S914 occurs when the result of Step S904 (and/or Step S906) is that there is no recording agreement between the company the user owns and the third-party label. Contract generation device 12 and user interface device 14 characterize the company as a “loan-out” type company, and the flow proceeds to step S916 and step S918.

In step S916, contract generation device 12 and user interface device 14 collect and store artist input information.

Step S918 involves collecting and storing company input information.

In step S920, if the response to S900 is “no” (or equivalent), contract generation device 12 directs the process flow to proceed to Step S922.

Step S922, performed by contract generation device 12 and user interface device 14, informs the user that they cannot be signed up, ensuring that only eligible users proceed with the onboarding process.

In step S924, as an example of an alternative user type, a manager user (e.g., a business manager or agent of a musical artist) may be available for configuration as a type of user, e.g., which may have a specially tailored contract generation flow.

For example, in one or more embodiments, one or more of the following user types may be available, and may be categorized as follows:
1. Artist, producer, engineer, songwriter;
2. Label or production company owner;
3. Manager;
4. Lawyers; and
5. Accountants.

In some embodiments, one or more privileges, such as contract review, modification, commenting, etc., privileges, may be assigned based on which user type and/or which user type category (e.g., of the above five user type categories) is associated with a particular user.

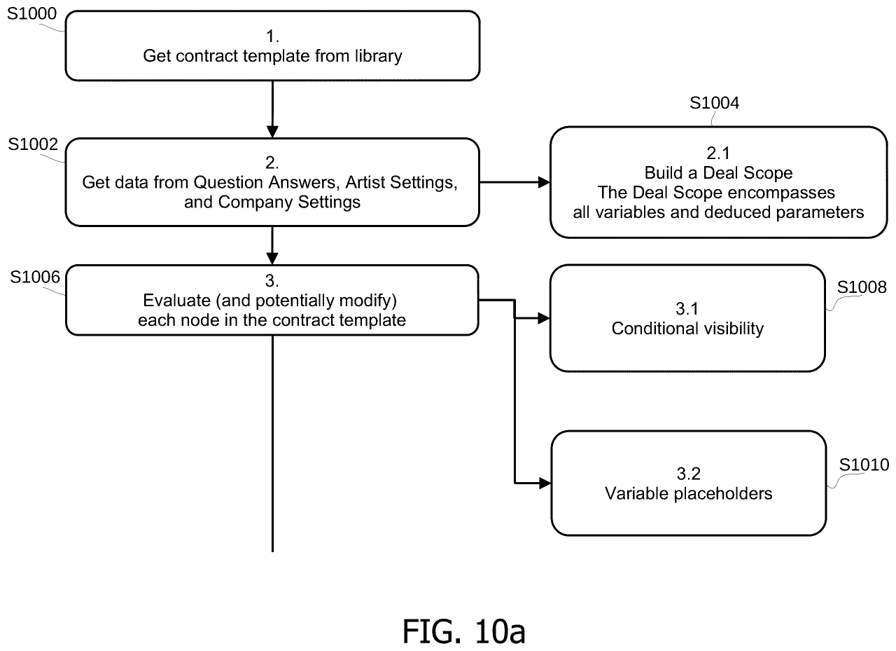

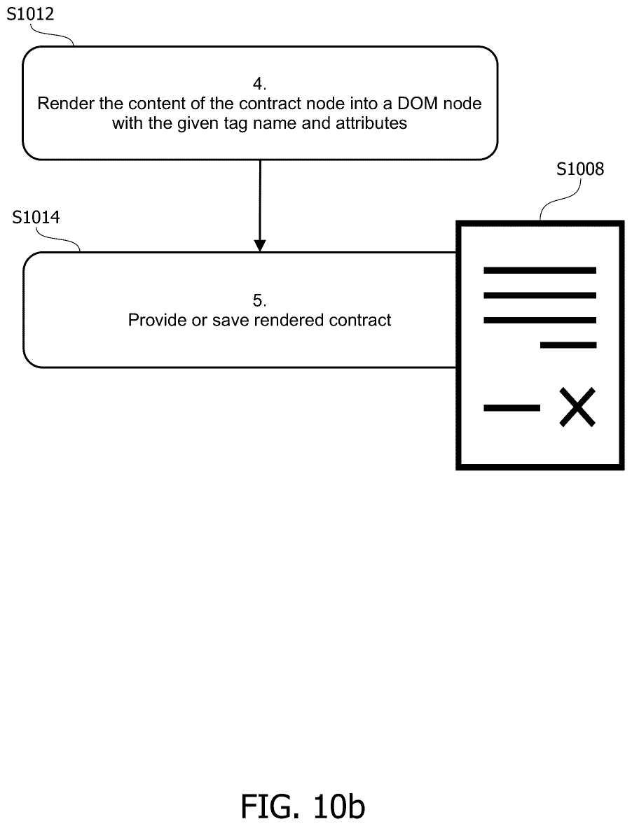

FIG. 10A and FIG. 10B taken together are process flow diagram which illustrates an example embodiment for contract rendering for a user of the user interface device 14 and contract generation device 12 for generating, managing, executing, etc. contracts in a music industry context (as an example context). One or more steps may be performed, for example, by one or more of data repository unit 19, contract renderer unit 20, and/or user interface engine unit 21.

In step S1000, contract generation device 12 retrieves a contract template from a library, e.g., using data repository unit 19, providing a foundation for the creation of the contract. The template may be preconfigured or received from another entity of system 10. Selection of the appropriate template (e.g., by contract generation device 12) may be based, e.g., on one or more artist attributes, company attributes, etc. The contract template may be comprised of a plurality of nodes and/or fields, corresponding to one or more provisions, inputs, variables, parameters, options, entities, parties, payments, nodes, etc. of the contract. For example, a node may be a paragraph or sentence fragment inside the contract, e.g., “Effective Date ______” may correspond to a node. In some embodiments, the contract and/or template thereof may be stored as and/or generated as a JSON file.

Some nodes, parameters, or variables may be derived (e.g., by contract generation device 12) based on the data and/or configurations set in the user/record company profiles and the relationships between these profiles.

For instance, in the case of a recording agreement, the contract generation device 12 may take into account the relationship between the artist and their label, and/or the label's recording agreement with the artist and any potential third-party relationships with distributors, for example.

An example that considers the relationship between profiles involves determining the ownership of the label company associated with an artist and whether a recording agreement is in place. If the artist exclusively owns the label and there is no recording agreement in place, the system recognizes the label as a “loan-out company” for the artist. This type of relationship is considered when determining which royalty provisions to include in the generated contract, for example.

It is to be understood that although a JSON data structure may be used to store deal scope or other data, the deal scope may be stored in various formats, data structures, etc., without deviating from the scope of the present disclosure.

Furthermore, in some embodiments, the contract generation device 12 may be configured to store relevant information in other industry-standard formats. For example, specific elements of the deal scope might be stored using the Common Works Registration (CWR) format, which is a protocol and data format for registering musical works.

Step S1002 involves contract generation device 12 obtaining data from the user's answers to questions (e.g., via a chatbot), (stored) artist settings, (stored) company settings, and/or other relevant sources, ensuring that the appropriate information is available to customize the contract template.

In step S1004, contract generation device 12, using the obtained data/attributes, determines a deal scope, which encompasses the variables and deduced variables (i.e., parameters) of the deal and/or contract and/or royalty structure, providing comprehensive information necessary to create and refine the contract.

Step S1006 is executed by contract generation device 12, which evaluates and potentially modifies each node (and/or field) in the contract template, tailoring the template to the unique requirements of the user(s) and/or parties involved (e.g., based on the deal scope).

In step S1008, contract generation device 12 determines conditional visibility variables corresponding, e.g., to whether certain aspects (e.g., fields, sub-fields, nodes, sub-nodes, variables, provisions, parameters, etc.) of the contract or template are included in the contract for the user(s) and/or signers, ensuring that only relevant information is displayed to each party, for instance.

In some embodiments, the contract generation device 12 may be configured to utilize a hierarchical structure of nodes within the contract template. For example, nodes may be organized in a hierarchical manner, with parent nodes encompassing one or more sub-nodes. The conditions of rendering applied to a parent node can also apply to its associated sub-nodes, ensuring that the contract structure remains coherent and contextually appropriate.

Furthermore, Step S1008, which involves determining conditional visibility parameters variables, may correspond to hiding or showing nodes in the contract template. The visibility rendering process ensures that provisions, sentence fragments, or other elements within the nodes (and/or sub-nodes) are displayed only when they are relevant to the particular contract. This step allows for the customization of the contract to suit the unique requirements and preferences of the involved parties, providing a streamlined and user-friendly experience.

Step S1010 involves contract generation device 12 determining variable placeholders corresponding to parts of the contract or template that are still yet to be determined, allowing for the flexibility to accommodate changes or additions to the contract.

Step S1011 involves contract generation device 12 enabling users to highlight a section of the generated contract language and suggest alternative wording. This feature may enable the users (e.g., a musical artist user, a record label representative user, etc.) to replace the relevant terms, variables, provisions, nodes, fields, etc., with an overridden version, further customizing the contract to their preferences.

The superseding language may then be acknowledged and/or approved in the same manner as other deal terms are considered and accepted.

Contract generation device 12 may be configured to determine which deal terms are affected by this superseding language, e.g., by analyzing the nodes included in the selected text, and bringing the changes to the user's attention (e.g., by highlighting/annotating them accordingly in the user interface device 14) for review and confirmation/rejection.

Additionally, contract generation device 12 may be configured to assess whether the superseded language impacts any provisions other than the one that is overridden, e.g., using node analysis, based on the hierarchical structure of nodes and sub-nodes, etc. This assessment may ensure that the contract remains coherent and consistent, taking into account the potential ramifications of the updated language on other parts of the agreement.

In step S1012, contract generation device 12 renders the content of the contract node into a document object model (DOM) node with the given tag name(s) and attributes, transforming the contract template into a presentable format.

In step S1014, contract generation device 12 provides and/or saves the rendered contract for the user(s), enabling the parties to access, review, and potentially sign the contract as needed.

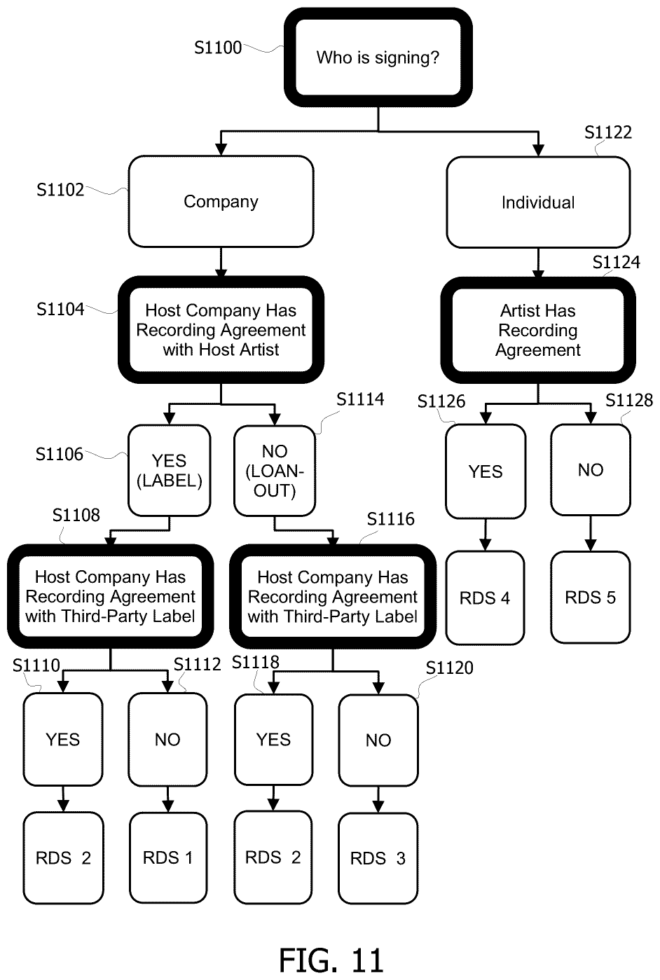

FIG. 11 is a process flow diagram which illustrates an example embodiment for royalty and/or deal scope determination for a user of the user interface device 14 and contract generation device 12 for generating, managing, executing, etc., contracts in a music industry context (as an example context). One or more steps may be performed, for example, by one or more of data repository unit 19, contract renderer unit 20, and/or user interface engine unit 21.

The Royalty Deal Structure is collaborative. While a single user can fill out the entire questionnaire, it can also be filled in simultaneously or asynchronously by many users. It has safety mechanisms. Because each song and sample is associated with an ISRC, ISWC, and IPIs when possible the system ensures that: a contract is a single contract in a collection of many contracts referencing the same song—and the system will not allow over-allocation of royalties; a song may include samples and other pre-established creative works—and that proper rights have been established; and, the relationship of users to companies is correct and can also ensure the artist signs an inducement letter when necessary.

In step S1100, contract generation device 12 determines who is signing the contract, whether it be a company or an individual, to ensure the appropriate deal scope is applied.

Step S1102 occurs when the signer determined in step S1100 is a company, and contract generation device 12 proceeds to step S1104.

In step S1104, contract generation device 12 determines whether the host company has a recording agreement with the host artist.

Step S1106 involves contract generation device 12 characterizing the company as a “Label” type company if the answer to Step S1104 is “yes”, and the flow proceeds to Step S1108.

In step S1108, contract generation device 12 determines whether the host company has a recording agreement with a third-party label.

Step S1110 occurs when the answer to step S1108 is “yes”, and contract generation device 12 assigns or applies a deal scope (called “RDS 2”) to the contract.

In step S1112, if the answer to step S1108 is “no”, contract generation device 12 assigns or applies a deal scope (called “RDS 1”) to the contract.

Step S1114 takes place when the answer to step S1104 is “NO”, and contract generation device 12 characterizes the company as a “loan-out” type company, with the process flow proceeding to Step S1116.

In step S1116, contract generation device 12 determines whether the host company has a recording agreement with a third-party label.

Step S1118 involves assigning or applying a deal scope “RDS 2” to the contract if the answer to step S1116 is “yes”.

In step S1120, if the answer to step S1116 is “no”, contract generation device 12 assigns or applies a deal scope “RDS 3” to the contract.

Step S1122 occurs when the response or determination in step S1100 is “individual”, and contract generation device 12 proceeds to Step S1124.

In step S1124, contract generation device 12 determines if the artist has a recording agreement.

Step S1126 involves assigning or applying a deal scope “RDS 4” to the contract if the answer to step S1124 is “yes”.

In step S1128, if the answer to step S1124 is “no”, contract generation device 12 assigns or applies a deal scope “RDS 5” to the contract.

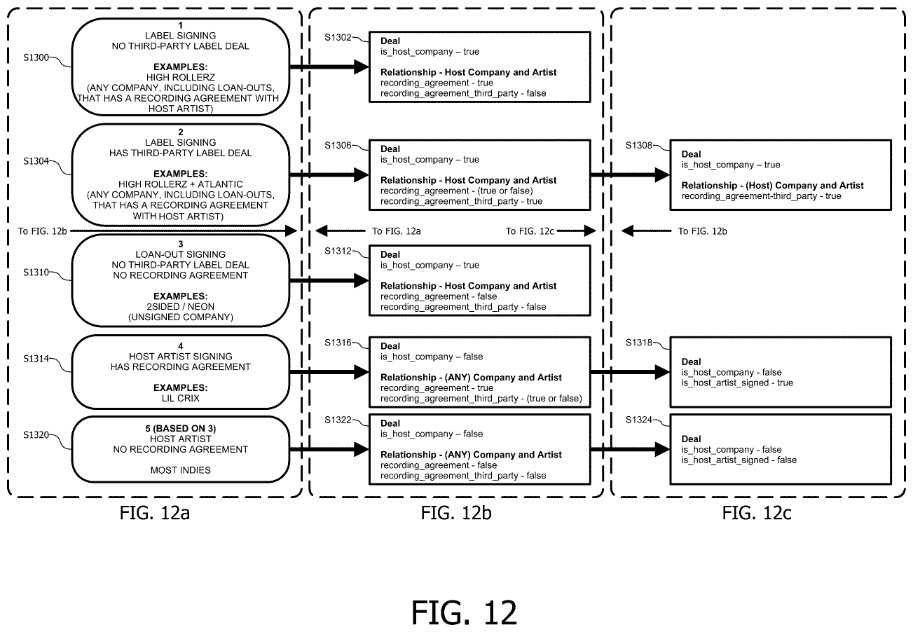

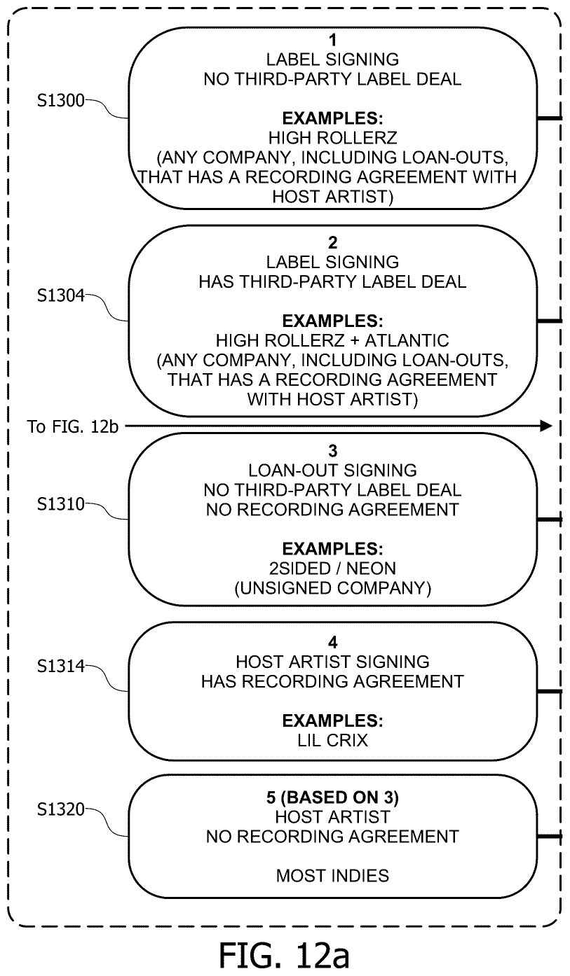

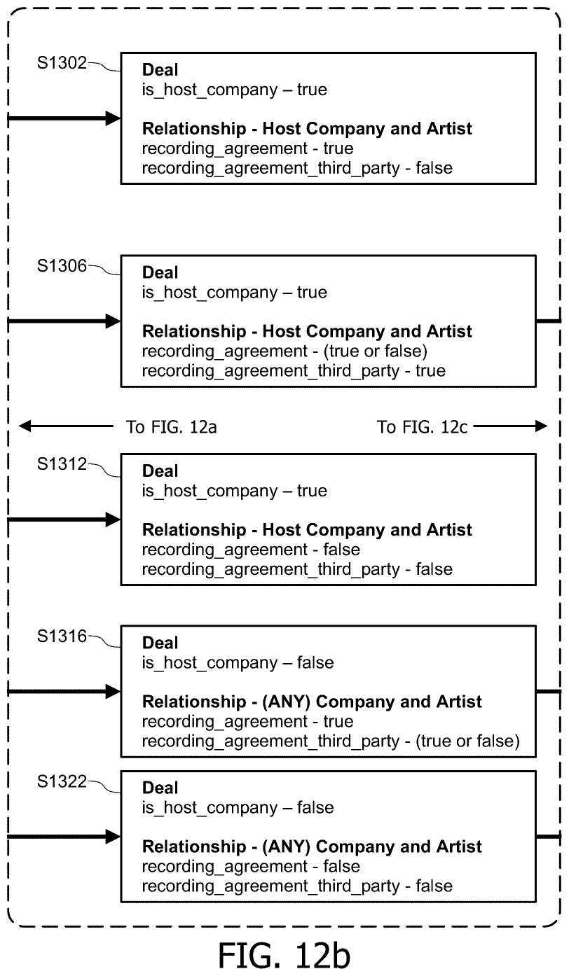

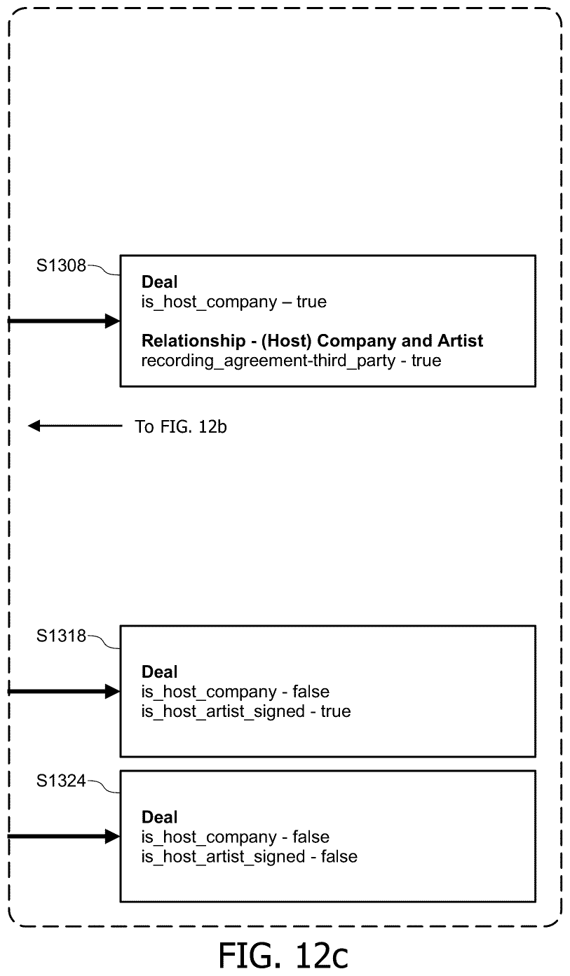

FIG. 12 is a diagram which illustrates example deal scope configurations according to one or more embodiments of the present disclosure, e.g., as implemented in a contract generation device 12. The example of FIG. 12 may not represent the entirety of a deal scope, and is intended as a visual illustration of an example of a portion of a deal scope. A “Royalty Deal Structure” parameter, for example, may be calculated as one of several components within the overall deal scope.

FIG. 12 outlines example logical steps and references example data used to ascertain the contractual relationship between the parties involved. By using this parameter in (Step S1006), for example, contract generation device 12 may be configured for identifying the appropriate set of royalty provisions to display to the various user(s) as they conduct the contract generation/revision/management process. One or more steps may be performed, for example, by one or more of data repository unit 19, contract renderer unit 20, and/or user interface engine unit 21.

Steps 1300 and 1302 describe determining a first deal scope, RDS 1, e.g., in a contract generation device 12, according to one or more embodiments. An RDS may be considered a “computed variable”, e.g., which may be part of a deal scope.

In step S1300, contract generation device 12 determines that the label company is signing and no third-party label deal is present. This may correspond, e.g., to an example scenario such as a loan-out company having a recording agreement with a host artist.

In step S1302, contract generation device 12 creates a deal scope data structure that reflects the inputs gathered in step S1300. The data structure includes the following fields:

The “is_host_company” field is set to “true”, indicating that the label company is signing the contract.

The “relationship” field is set to “host company and artist”, specifying the relationship between the signing parties.

The “recording_agreement” field is set to “true”, signifying that there is a recording agreement between the host company and the artist.

The “recording_agreement_third_party” field is set to “false”, denoting that there is no recording agreement between the host company and a third-party label.

By establishing these fields within the deal scope data structure, contract generation device 12 effectively captures the necessary information to define the first deal scope, enabling the system to generate a contract that is tailored to the unique requirements of the involved parties.

Steps S1304, S1306, and S1308 describe determining a second deal scope, RDS 2, e.g., in a contract generation device 12, according to one or more embodiments.

In step S1304, contract generation device 12 determines that the label company is signing the contract and has a third-party label deal. This may correspond, for instance, to an example where a company, such as a loan-out, has a recording agreement with a host artist.

In step S1306, contract generation device 12 creates a deal scope data structure based on the inputs gathered in step S1304. The data structure includes the following fields:

The “is_host_company” field is set to “true”, indicating that the label company is signing the contract.

The “relationship” field is set to “host company and artist”, specifying the relationship between the signing parties.

The “recording_agreement” field is set to “true” or “false”, depending on the presence of a recording agreement between the host company and the artist.

The “recording_agreement_third_party” field is set to “true”, denoting that there is a recording agreement between the host company and a third-party label.

In step S1308, contract generation device 12 creates another deal scope data structure, with the following fields:

The “is_host_company” field is set to “true”, indicating that the label company is signing the contract.

The “relationship” field is set to “host company and artist”, specifying the relationship between the signing parties.

The “recording_agreement_third_party” field is set to “true”, signifying that there is a recording agreement between the host company and a third-party label.

By establishing these fields within the second deal scope data structure, contract generation device 12 effectively captures the necessary information to define the second deal scope, enabling the system to generate a contract that is tailored to the unique requirements of the involved parties, considering the presence of a third-party label deal.

Steps S1310 and S1312 describe determining a third deal scope, e.g., RDS 3, e.g., in a contract generation device 12, according to one or more embodiments.

In step S1310, contract generation device 12 determines that a loan-out company is signing the contract, no third-party label deal is present, and there is no recording agreement. This may correspond, for instance, to an unsigned company.

In step S1312, contract generation device 12 creates a deal scope data structure based on the inputs gathered in step S1310. The data structure includes the following fields:

The “is_host_company” field is set to “true”, indicating that the loan-out company is signing the contract.

The “relationship” field is set to “host company and artist”, specifying the relationship between the signing parties.

The “recording_agreement” field is set to “false”, denoting the absence of a recording agreement between the host company and the artist.

The “recording_agreement_third_party” field is set to “false”, signifying that there is no recording agreement between the host company and a third-party label.

By establishing these fields within the third deal scope data structure, contract generation device 12 effectively captures the necessary information to define the third deal scope. This enables the system 10 to generate a contract that is tailored to the unique requirements of the involved parties, taking into consideration the absence of both a recording agreement and a third-party label deal.

Steps S1314, S1316, and S1318 describe determining a fourth deal scope, RDS 4, e.g., in a contract generation device 12, according to one or more embodiments.

In Step S1314, contract generation device 12 determines that a host artist is signing the contract, and the host artist has a recording agreement in place.

In Step S1316, contract generation device 12 creates a deal scope data structure based on the inputs gathered in Step S1314. The data structure includes the following fields:

The “is_host_company” field is set to “false”, indicating that the host artist, not a company, is signing the contract.

The “relationship” field is set to “(any) company and artist”, specifying the relationship between the signing parties.

The “recording_agreement” field is set to “true”, denoting the presence of a recording agreement involving the host artist.

The “recording_agreement_third_party” field is set to “true or false”, indicating that the host artist may or may not have a recording agreement with a third-party label.

In Step S1318, contract generation device 12 determines another deal scope data structure, in which the “is_host_company” field is set to “false”, signifying that the host artist is signing the contract, and the “is_host_artist_signed” field is set to “true”, confirming that the host artist has a recording agreement in place.

By establishing these fields within the fourth deal scope data structure, contract generation device 12 effectively captures the necessary information to define the fourth deal scope. This enables the system to generate a contract that is tailored to the unique requirements of the involved parties, taking into account the host artist's recording agreement status.

Steps S1320, S1322, and S1324 describe determining a fifth deal scope, RDS 5, e.g., in a contract generation device 12, according to one or more embodiments.

In Step S1320, contract generation device 12 determines that a host artist is signing the contract, and the host artist has no recording agreement in place. This scenario may correspond to a typical independent artist who is not currently signed to a record label.

In Step S1322, contract generation device 12 establishes a deal scope data structure based on the inputs gathered in Step S1320. The data structure includes the following fields:

The “is_host_company” field is set to “false”, indicating that the host artist, not a company, is signing the contract.

The “relationship” field is set to “(any) company and artist”, specifying the relationship between the signing parties.

The “recording_agreement” field is set to “false”, denoting the absence of a recording agreement involving the host artist.

The “recording_agreement_third_party” field is set to “false”, indicating that the host artist does not have a recording agreement with a third-party label.

In Step S1324, contract generation device 12 determines another deal scope data structure, in which the “is_host_company” field is set to “false”, signifying that the host artist is signing the contract, and the “is_host_artist_signed” field is set to “false”, confirming that the host artist does not have a recording agreement in place.

By defining these fields within the fifth deal scope data structure, contract generation device 12 effectively captures the necessary information to define the fifth deal scope. This allows the system to generate a contract that is tailored to the unique requirements of the involved parties, considering the host artist's lack of a recording agreement.

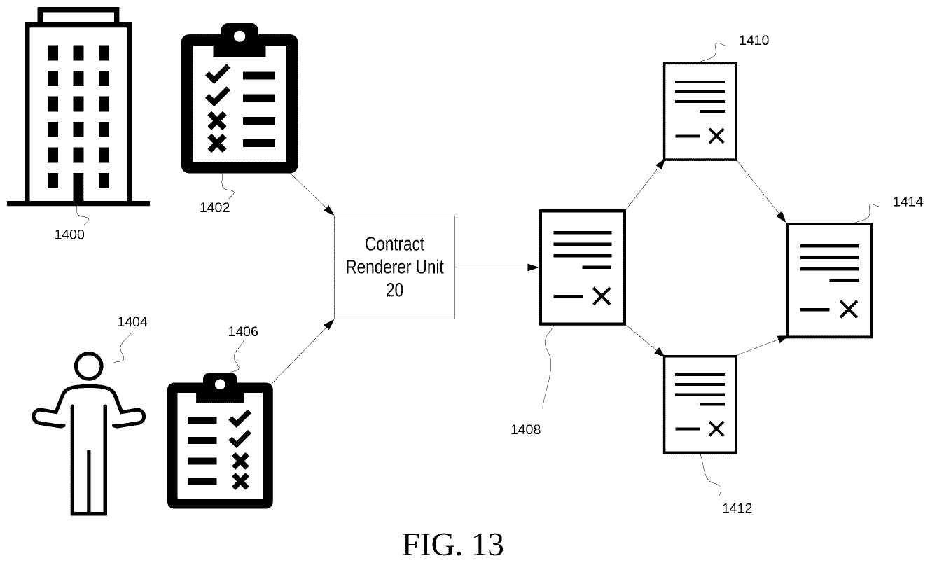

FIG. 13 illustrates another example process flow for some embodiments of the present disclosure. For example, a company 1400 may be associated with a set of attributes 1402, and an artist user 1404 is associated with a set of attributes 1406. The attributes 1402 and 1406 may be retrieved by the onboarding unit 18, data repository unit 19, contract generation device 12, user interface device 14, or other components within the system. The attributes may be collected from a user and/or from data stored in a repository, and/or data associated with other contracts.

The attributes 1402 and 1406 (e.g., as determined by onboarding unit 18 and/or data repository unit 19, not shown in FIG. 13) may be provided to the contract renderer unit 20, which may employ a rules-based approach, such as a decision tree, for example, to render at least one draft contract 1408, as described herein, which reflects the attributes of the company 1400 and artist user 1404, and which is based on the deal scope as determined by contract renderer unit 20.

The draft contract 1408 may be reviewable by the company 1400 and/or the artist user 1404, e.g., via user interface device 14, which may enable the company 1400 and/or artist user 1404 to input comments, edits, flags, counterproposals, etc., to the draft contract 1408.

In some embodiments, multiple contract sub-versions 1410 and 1412 are generated by contract renderer unit 20 from the draft contract 1408. For example, sub-version 1410 may be tailored for the company 1400, while sub-version 1412 may be tailored for the artist user 1404. The artist user 1404 may edit, revise, or otherwise modify sub-version 1412, and the company 1400 may edit, revise, or otherwise modify sub-version 1410.

The two sub-versions 1412 and 1410 may differ in various aspects, such as information visibility for one type of user but not another, visibility of comments, edits, or revisions made by the various users, etc. After the collaborative editing process is completed by the artist user 1404 and the company 1400, the two sub-versions 1412 and 1410 are compiled by contract renderer unit 20 (or another entity of system 10) into a single final version 1414.

This final version 1414 reflects the negotiated terms and provisions agreed upon by both the artist user 1404 and the company 1400, based on their collaborative editing efforts. This embodiment streamlines the contract generation and negotiation process, ensuring a more efficient and interactive experience for all parties involved. A rules-based approach may also ensure compliance with existing agreements, and minimize the risk of inadvertently breaching an agreement.

### Example 7

The following is an example in accordance with embodiments such as the example described in FIG. 13. User A (musical artist) and User B (record label company representative) want to generate a draft contract for music royalties between them. The following steps describe the generation of a royalty deal scope based on the attributes of the users, decisions and preferences of the users, responses to chatbot questions, and legal and regulatory requirements, among other variables. The following example is not limited to these types of users, and may be applicable to and/or may accommodate other types of users, such as attorneys/agents/business managers representing one or more parties, third-party beneficiaries, financers, etc.

### Step 7-1: Onboarding

User A and User B input their respective attributes into the contract generation device. For User A (artist user), this might include their stage name, legal name, contact information, musical genre, past contracts, and past royalties received. For User B (company), attributes might include the company name, contact information, legal jurisdiction, contract history, and standard royalty rates.

### Step 7-2: Data Retrieval

The onboarding unit 18 retrieves these attributes and may also gather additional data from the data repository unit 19, which stores information on past contracts, industry standards, legal and regulatory requirements, and other relevant data.

### Step 7-3: User Preferences and Chatbot Interaction

The user interface device 14 may present User A and User B with a series of questions or options to refine the contract's scope. These questions could address royalty rates, advance payments, territory rights, and contract duration, among other details. Both users provide their preferences and responses to the chatbot, and/or other input methods (graphic button selection, text-based form input, etc.).

### Step 7-4: Deal Scope Determination

Based on the input from both users, as well as data collected from the onboarding unit 18 and data repository unit 19, the contract renderer unit 20 determines a deal scope for the draft contract. The deal scope will consider the attributes of User A and User B, their decisions and preferences, responses to chatbot questions, and legal and regulatory requirements.

### Step 7-5: Contract Rendering

Utilizing a rules-based approach, such as a decision tree, the contract renderer unit 20 generates a draft contract, such as a JSON object or other data structure, which may be comprised of nodes, such as a tree of nodes, where nodes correspond to provisions and sub-provisions of the draft contract. The draft contract reflects the attributes of User A (artist user) and User B (company), and is based on the deal scope determined in Step 7-4. The draft contract may include clauses on royalty rates, advance payments, territory rights, contract duration, and any other relevant terms, for example.

### Step 7-6: Draft Contract Review

User A and User B review the draft contract, making any necessary revisions or adjustments. They can continue to interact with the chatbot or other system components to refine the contract until both parties are satisfied with the terms.

### Step 7-7: Finalization and Execution

Once both parties agree on the draft contract, they may finalize and execute the agreement. The contract is stored within the system for future reference, and its data may be utilized by the data repository unit 19 to improve future contract generation processes.

In this example, the contract generation device efficiently creates a royalty deal scope and draft contract based on the attributes, decisions, preferences, and legal requirements relevant to User A (musical artist) and User B (record label company representative).

### Example 8

In a machine learning extension to some of the embodiments described herein, a machine learning model may be introduced to enhance the contract generation process. The model assists in determining at least one term, provision, sub provision, attribute, node, sub node, parameter, and/or variable of the draft contract and/or deal scope between User A (musical artist) and User B (record label company representative). The model may be trained on historical user preferences, attributes, legal and regulatory requirements, and other relevant data. The response data corresponds to “final” contract terms, attributes, nodes, parameters, and variables from finalized and executed contracts and/or deal scopes between historical users.

### Step 8-1: Data Preparation

Data from past executed contracts is collected, cleaned, and preprocessed. The input data includes historical user attributes, preferences, legal and regulatory requirements, and other contract-related information and/or deal-scope related information. The response data includes finalized and executed contract/deal-scope terms, attributes, nodes, parameters, and variables.

### Step 8-2: Model Training

A suitable machine learning model, such as a neural network, decision tree, or ensemble model, is selected and trained on the prepared input data. The model learns patterns and relationships between user attributes, preferences, legal requirements, and the finalized contract terms/deal-scopes.

### Step 8-3: Model Integration

The trained machine learning model is integrated into the contract generation device, working alongside or instead of the rules-based contract renderer unit 20.

### Step 8-4: User Onboarding and Data Retrieval

Similar to the previous example, User A and User B input their respective attributes, and the onboarding unit 18 retrieves these attributes along with additional data from the data repository unit 19.

### Step 8-5: User Preferences and Chatbot Interaction

The user interface device 14 presents User A and User B with a series of questions or options to refine the contract's scope or deal-scope, and both users provide their preferences and responses to the chatbot.

Step 8-6: Deal Scope Determination and Machine Learning Model PredictionThe contract renderer unit 20 determines the deal scope using the input from both users, as well as data collected from the onboarding unit 18 and data repository unit 19. Simultaneously, the integrated machine learning model predicts at least one term, attribute, node, parameter, and/or variable for the draft contract/deal-scope based on the user input data and historical contract patterns and/or deal-scope patterns.

Step 8-7: Contract Rendering with Machine Learning Model Predictions

The contract renderer unit 20 generates a draft contract that includes the machine learning model's predictions. The draft contract reflects the attributes of User A and User B and is based on the deal scope determined in Step 8-6, as well as the machine learning model's output.

### Step 8-8: Draft Contract Review

User A and User B review the draft contract, making any necessary revisions or adjustments. They can continue to interact with the chatbot or other system components to refine the contract until both parties are satisfied with the terms.

### Step 9: Finalization and Execution

Once both parties agree on the draft contract, they finalize and execute the agreement. The contract is stored within the system for future reference, and its data may be utilized by the data repository unit 19 and the machine learning model to improve future contract generation processes.

### Step 10: Automated Contract Summarization

In a further embodiment, one or more machine learning (and/or other artificial intelligence methods, such as a large language model (LLM)) may be employed for summarizing a contract and/or deal scope, for example, based on the plain text of the contract/deal-scope and/or based on at least one term, attribute, node, parameter, and/or variable associated with the contract/deal-scope. A summarization process may include, for example, generating a graphical and/or tabular display of pertinent contract terms (e.g., royalty percentages, payment amounts, fees, relevant dates or time periods, etc.) and/or a machine-generated narrative description. For example, in some embodiments, a machine learning model may be trained, e.g., using contracts/deal-scopes as input data (represented as plain text of and/or at least one term, attribute, node, parameter, and/or variable for a particular contract/deal-scope) and the response data may include, e.g., corresponding contract/deal-scope summaries and/or code (e.g., R source code) used for displaying graphics/tables/etc. based on the input data. In this way, the trained machine learning model may predict/generate an accurate summary and/or appropriate source code for summarizing a given contract text or set of at least one term, attribute, node, parameter, and/or variable for a particular contract/deal-scope.

By incorporating a machine learning model into the contract generation process, the system can more accurately predict and suggest contract terms, attributes, nodes, parameters, and variables based on historical data, leading to a more efficient and tailored contract drafting experience for User A and User B. Additionally, a machine learning model and/or LLM may be used to summarize a contract in the form of narrative text and/or a graphical/tabular display.

### Example 9

In some embodiments, a machine learning model may be designed to work with a tree of nodes, where each node corresponds to a potential provision of a draft contract. The model is used to determine which nodes to show or hide in the draft contract, and by default, when a node is shown or hidden, its sub nodes are also shown or hidden. Note that other settings or default settings may be configured depending on the particular node, e.g., where some sub nodes may not have the same properties of its parent node, and may be shown or hidden even if the parent is not shown or not hidden, respectively.

### Step 9-1: Data Preparation

Past executed contracts are represented as trees of nodes, with each node corresponding to a contract provision, and sub nodes corresponding to sub provisions. The input data includes historical user attributes, preferences, legal and regulatory requirements, and other contract-related information. The response data includes binary labels indicating whether each node was shown (1) or hidden (0) in the finalized contract.

### Step 9-2: Model Training

A suitable machine learning model, such as a neural network or decision tree, is selected and trained on the prepared input data. The model learns patterns and relationships between user attributes, preferences, legal requirements, and the inclusion or exclusion of nodes in the finalized contract.

### Step 9-3: Model Integration

The trained machine learning model is integrated into the contract generation device, working alongside the rules-based contract renderer unit 20.

### Step 9-4: User Onboarding and Data Retrieval

User A and User B input their respective attributes, and the onboarding unit 18 retrieves these attributes along with additional data from the data repository unit 19.

### Step 9-5: User Preferences and Chatbot Interaction

The user interface device 14 presents User A and User B with a series of questions or options to refine the contract's scope, and both users provide their preferences and responses to the chatbot.

### Step 9-6: Deal Scope Determination and Machine Learning Model Prediction

The contract renderer unit 20 determines the deal scope using the input from both users, as well as data collected from the onboarding unit 18 and data repository unit 19. Simultaneously, the integrated machine learning model predicts which nodes should be shown or hidden in the draft contract based on the user input data and historical contract patterns.

Step 9-7: Contract Rendering with Machine Learning Model Predictions

The contract renderer unit 20 generates a draft contract by traversing the tree of nodes, and including or excluding nodes based on the machine learning model's predictions. By default, if a node is shown or hidden, its subnodes are also shown or hidden.

### Step 9-8: Draft Contract Review

User A and User B review the draft contract, making any necessary revisions or adjustments. They can interact with the chatbot or other system components to refine the contract, including adding or removing nodes and their corresponding subnodes.

### Step 9-9: Finalization and Execution

Once both parties agree on the draft contract, they finalize and execute the agreement. The contract is stored within the system for future reference, and its data may be utilized by the data repository unit 19 and the machine learning model to improve future contract generation processes.

### Examples 10.1, 10.2, and 10.3

In a further set of examples according to one or more of the above-described embodiments, both the first and second users are individual and/or independent artists, not associated with any company.

Example 10.1: Two independent musicians (User A and User B) are collaborating on a joint album. They interact with the dynamic questionnaire/chatbot (contract generation device 12, user interface device 14, onboarding unit 18, etc.) to provide their individual attributes and preferences. Contract renderer unit 20 uses these attributes to generate a draft contract that outlines the division of royalties, responsibilities for marketing and promotion, and terms for future performances related to the album.

Example 10.2: User A, an independent artist, and User B, a freelance producer, are planning a project. They input their details and preferences into the system (contract generation device 12, user interface device 14, onboarding unit 18, etc.), and contract renderer unit 20 generates a contract outlining the roles, responsibilities, payment terms, and intellectual property rights.

Example 10.3: Two independent artists (User A and User B) are planning a co-headlined tour. They input their preferences into the system (contract generation device 12, user interface device 14, onboarding unit 18, etc.), and contract renderer unit 20 generates a draft contract that reflects these inputs, which they can then edit and refine before finalizing.

### Examples 11.1, 11.2, and 11.3

In a further set of examples according to one or more of the above-described embodiments, the first user is an individual and/or independent artist, and the second user is an artist associated with a company.

Example 11.1: User A, an independent rapper, is being featured on a track by User B, an artist signed to a record label. The system (contract generation device 12, user interface device 14, onboarding unit 18, etc.) is used to generate a contract that outlines terms such as compensation for User A, distribution of royalties, and marketing responsibilities.

Example 11.2: User A, an independent artist, is hired by a record label (User B) to write songs for one of their signed artists. Contract renderer unit 20 generates a contract outlining payment terms, song ownership, and future royalties based on the preferences and details input into the system (contract generation device 12, user interface device 14, onboarding unit 18, etc.).

Example 11.3: User B, a record label, wants to sign User A, an independent artist, for a single album. Both parties use the system (contract generation device 12, user interface device 14, onboarding unit 18, etc.) to provide their preferences and contract renderer unit 20 generates a draft contract outlining terms such as advance payment, royalty rates, and creative control.

### Examples 12.1, 12.2, and 12.3

In a further set of examples according to one or more of the above-described embodiments, the first user is an artist who is associated with a company, and the second user is also an artist associated with a company.

Example 12.1: User A and User B are two artists, each signed to different record labels, collaborating on a track. Contract renderer unit 20 generates a contract that outlines how royalties will be split between the two labels, as well as terms for marketing and promotion based on the attributes and preferences provided through the system (contract generation device 12, user interface device 14, onboarding unit 18, etc.).

Example 12.2: User A, an artist under a management company, wants to collaborate with User B, an artist signed to a record label, for a live concert tour. Both parties input their preferences and contractual requirements into the system (contract generation device 12, user interface device 14, onboarding unit 18, etc.). Contract renderer unit 20 then generates a draft contract that includes terms related to profit sharing, merchandise rights, and tour responsibilities.

Example 12.3: User A and User B are artists both signed to the same record label and are releasing a joint album. They use the system (contract generation device 12, user interface device 14, onboarding unit 18, etc.) to input their individual preferences for aspects such as royalty division, marketing responsibilities, and future performances related to the album. Contract renderer unit 20 uses this information to generate a draft contract tailored to the unique needs and expectations of both parties.

### Examples 13.1, 13.2, and 13.3

In a further set of examples according to one or more of the above-described embodiments, the first user is an artist who is not associated with a company, and the second user is a non-artist (e.g., manager, agent, business representative, account manager, attorney, etc.) who is not associated with a company.

Example 13.1: User A, an independent artist, wants to formalize an agreement with User B, a freelance manager. Using the system (contract generation device 12, user interface device 14, onboarding unit 18, etc.), they input their preferences and requirements. Contract renderer unit 20 generates a draft contract outlining the terms of their professional relationship, such as responsibilities, commission percentages, and dispute resolution procedures.

Example 13.2: User A, an artist without a label, wishes to contract User B, an independent attorney, to provide legal services for a specific legal matter. The system (contract generation device 12, user interface device 14, onboarding unit 18, etc.) facilitates the input of specific legal requirements and conditions from both parties. Contract renderer unit 20 then generates a draft contract detailing the scope of the legal services, compensation, and confidentiality terms.

Example 13.3: User A, an independent artist, is looking to collaborate with User B, a business representative, to explore merchandising opportunities. Both parties use the system (contract generation device 12, user interface device 14, onboarding unit 18, etc.) to input their preferences and requirements. Contract renderer unit 20 generates a draft contract that includes terms related to profit sharing, merchandise design, production, and distribution.

### Examples 14.1, 14.2, and 14.3

In a further set of embodiments and/or use cases according to one or more of the above-described embodiments, the first user is an artist who is not associated with a company, and the second user is a non-artist who is associated with a company.

Example 14.1: User A, an independent artist, is negotiating a single album distribution deal with User B, a representative from a music distribution company. They each input their contractual preferences into the system (contract generation device 12, user interface device 14, onboarding unit 18, etc.). Contract renderer unit 20 then generates a draft contract outlining the terms of the agreement, such as distribution channels, promotional activities, and royalty rates.

Example 14.2: User A, an independent artist, wants to secure representation from User B, an agent associated with a talent agency. Using the system (contract generation device 12, user interface device 14, onboarding unit 18, etc.), they input their respective preferences and requirements. Contract renderer unit 20 generates a draft contract that includes terms such as the agent's commission rate, the duration of the agreement, and the extent of the agent's authority.

Example 14.3: User A, an independent artist, is looking to sign a recording contract with User B, a representative from a record label. They use the system (contract generation device 12, user interface device 14, onboarding unit 18, etc.) to input their respective preferences and requirements. Contract renderer unit 20 generates a draft contract that includes terms related to album production, marketing, promotion, and royalty payments.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

Many different embodiments have been disclosed herein, in connection with the above description and the drawings. It will be understood that it would be unduly repetitious and obfuscating to literally describe and illustrate every combination and sub combination of these embodiments. Accordingly, all embodiments can be combined in any way and/or combination, and the present specification, including the drawings, shall be construed to constitute a complete written description of all combinations and sub combinations of the embodiments described herein, and of the manner and process of making and using them, and shall support claims to any such combination or sub combination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings and following embodiments of the contract generation devices that make use of some of the inventions described herein.

### Example Embodiments

Embodiment A1. A contract generation device comprising processing circuitry configured to:

request and/or receive onboarding information from a first user and a second user, each of the first and second users being at least one of an artist and a company;

determine, based on the onboarding information, a deal scope for the first user and the second user; and

dynamically render a draft contract for the first user and the second user based on the deal scope.

Embodiment A2. The contract generation device of Embodiment A1, wherein the contract includes a plurality of nodes, each node being dynamically determined based on the deal scope and the onboarding information.

Embodiment A3. The contract generation device of any of Embodiments A1 and A2, wherein the deal scope is determined at least in part based on a pre-existing contractual relationship between the first user and the second user.

Embodiment A4. The contract generation device of any of Embodiments A1-A3, the deal scope is determined at least in part based on a pre-existing relationship between the first user and a third-party company not associated with the contract.

Embodiment A5. The contract generation device of any of Embodiments A1-A4, wherein the rendered contract is provided to the first user and the second user for enabling collaborative editing of the contract.

Embodiment B1. A method implemented in a contract generation device, the method comprising:

requesting and/or receiving (Block S100) onboarding information from a first user and a second user, each of the first and second users being at least one of an artist and a company;

determining (Block S102), based on the onboarding information, a deal scope for the user; and

dynamically rendering (Block S104) a draft contract based on the deal scope.

Embodiment B2. The method of Embodiment B1, wherein the contract includes a plurality of nodes, each node being dynamically determined based on the deal scope and the onboarding information.

Embodiment B3. The method of any of Embodiments B1 and B2, wherein the deal scope is determined at least in part based on a pre-existing relationship between the first user and the second user.

Embodiment B4. The method of any of Embodiments B1-B3, the deal scope is determined at least in part based on a pre-existing relationship between the first user and a third-party company not associated with the contract.

Embodiment B5. The method of any of Embodiments B1-B4, wherein the rendered contract is provided to the first user and the second user for enabling collaborative editing of the contract.

Embodiment B5. The method of any of Embodiments B1-B4, wherein the rendered contract is provided to the first user and the second user for enabling collaborative editing of the contract.

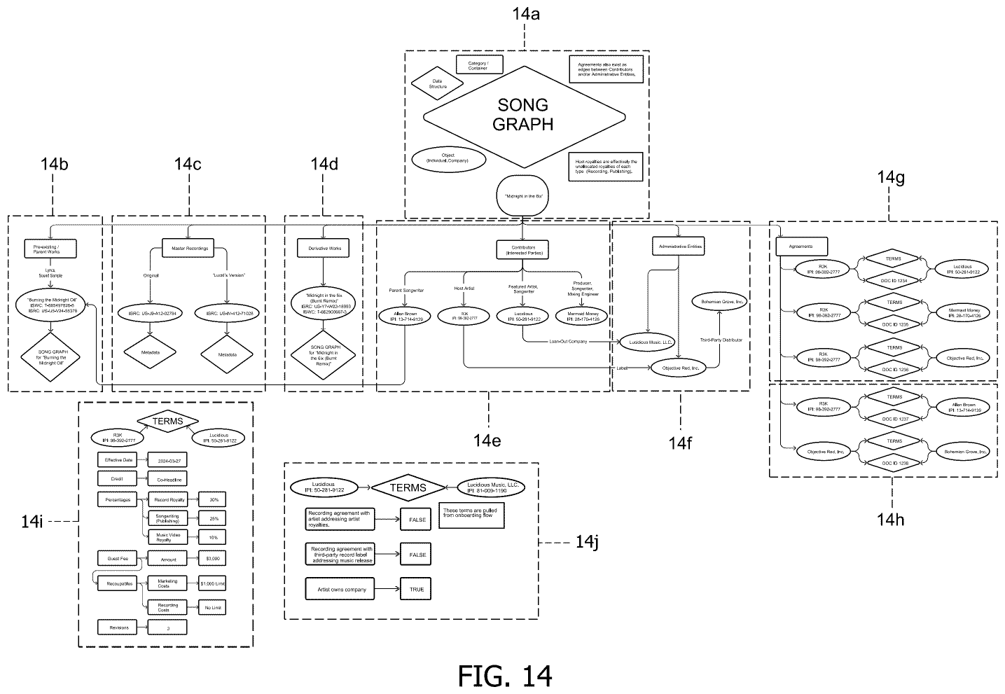

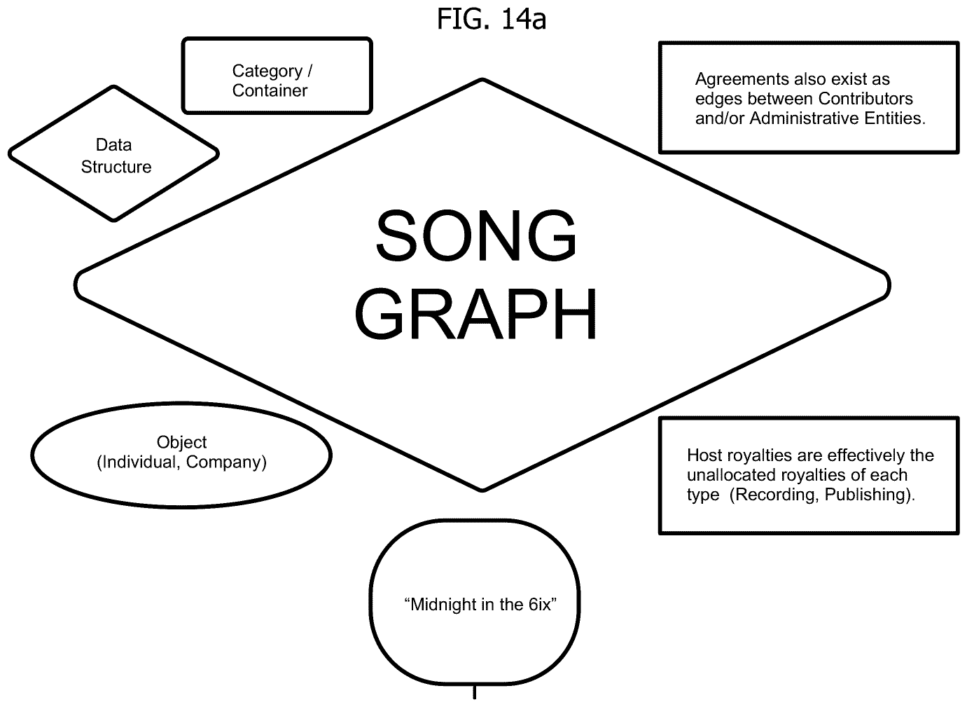

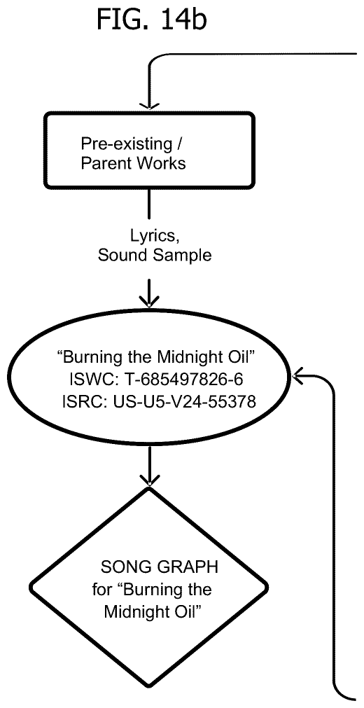

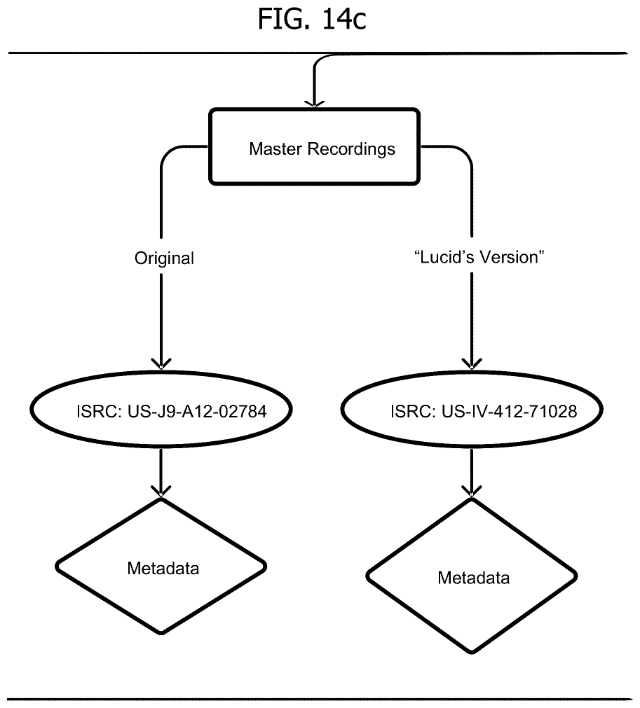

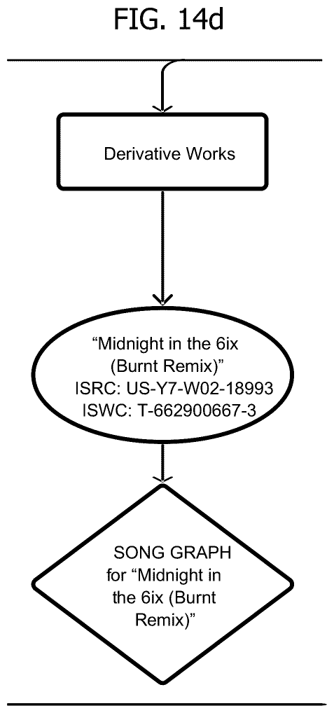

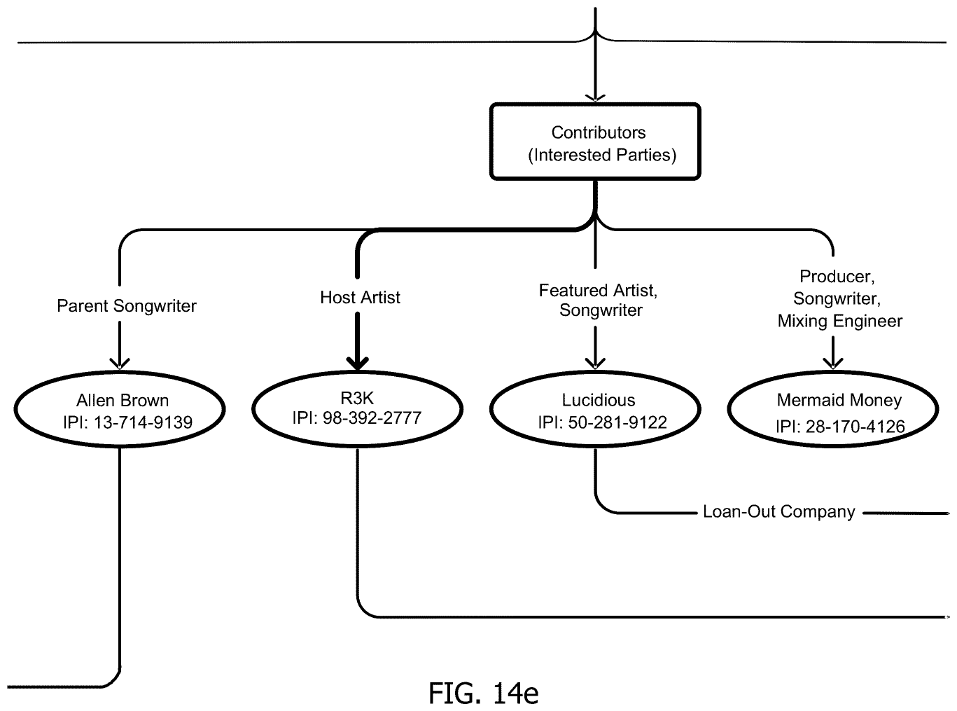

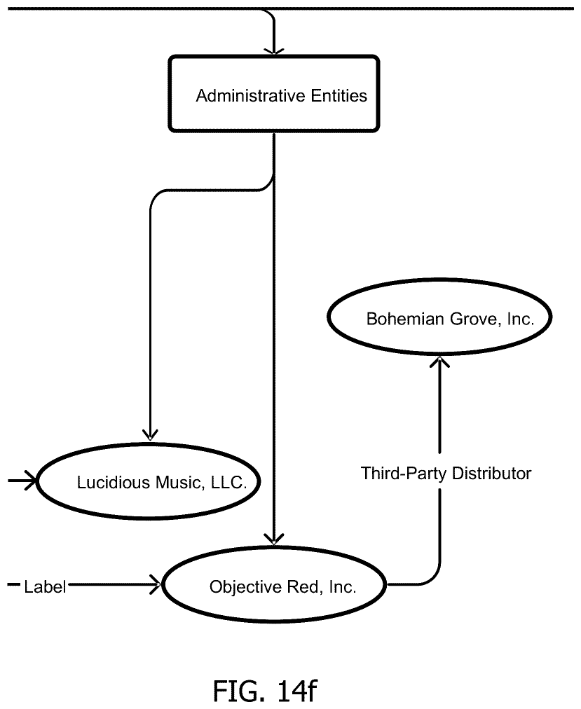

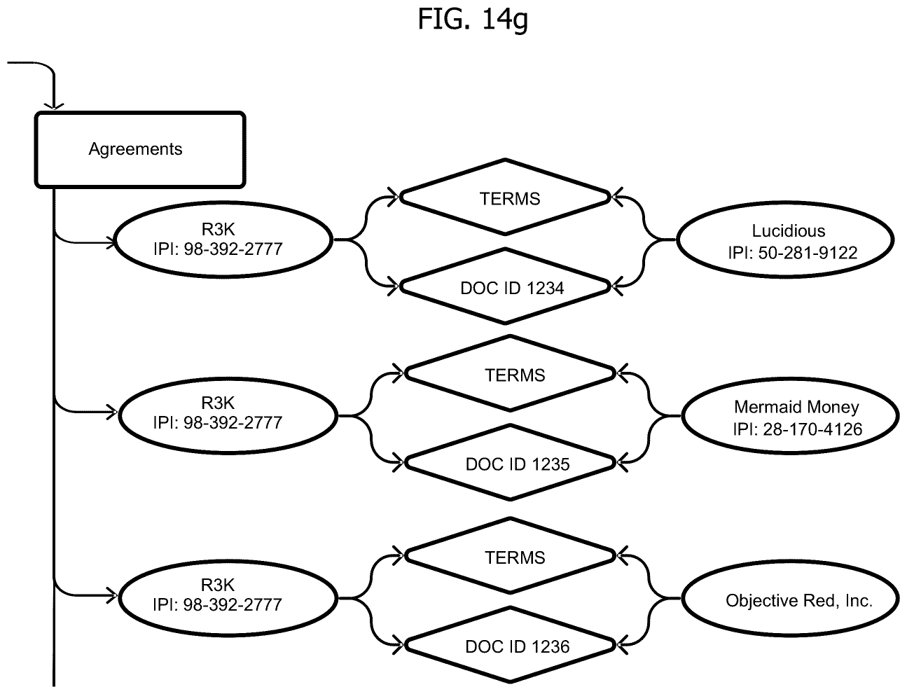

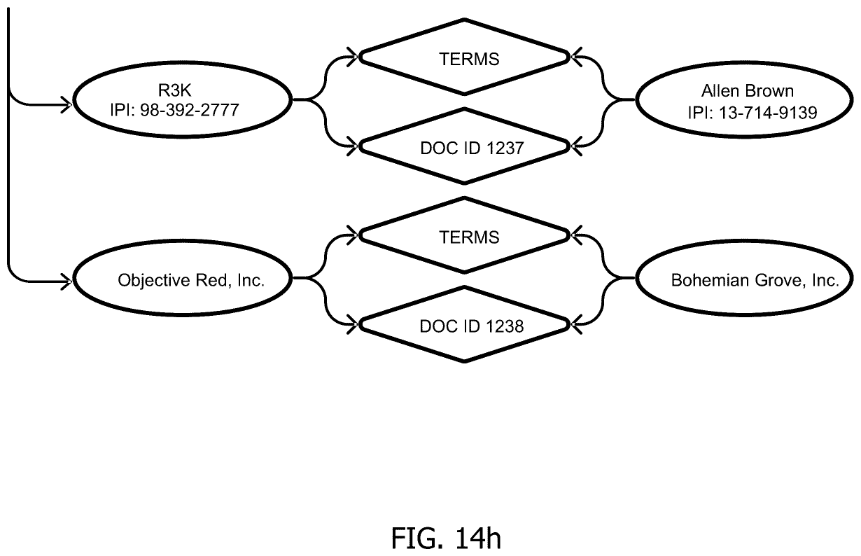

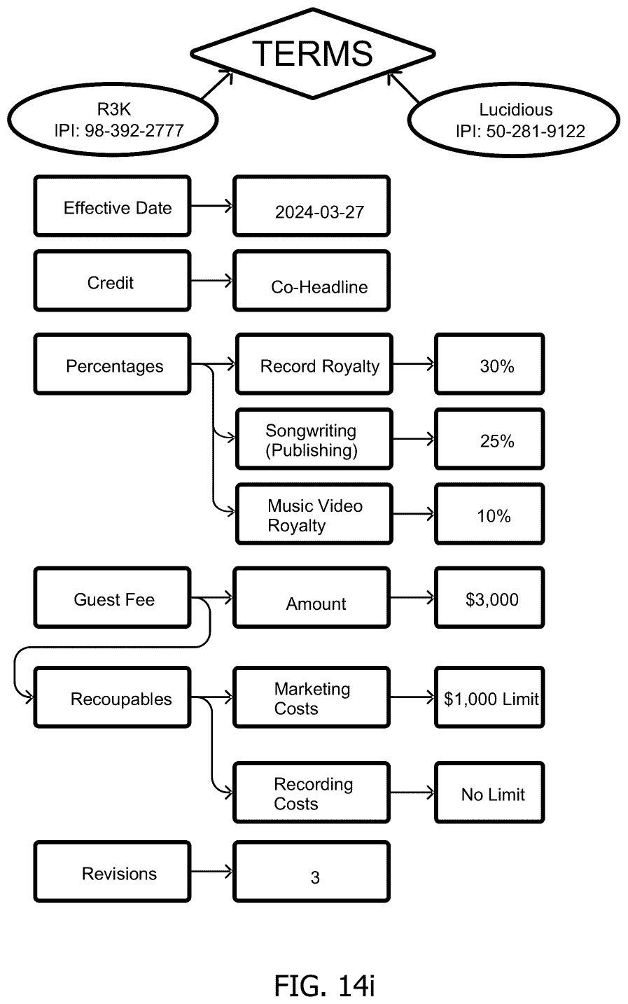

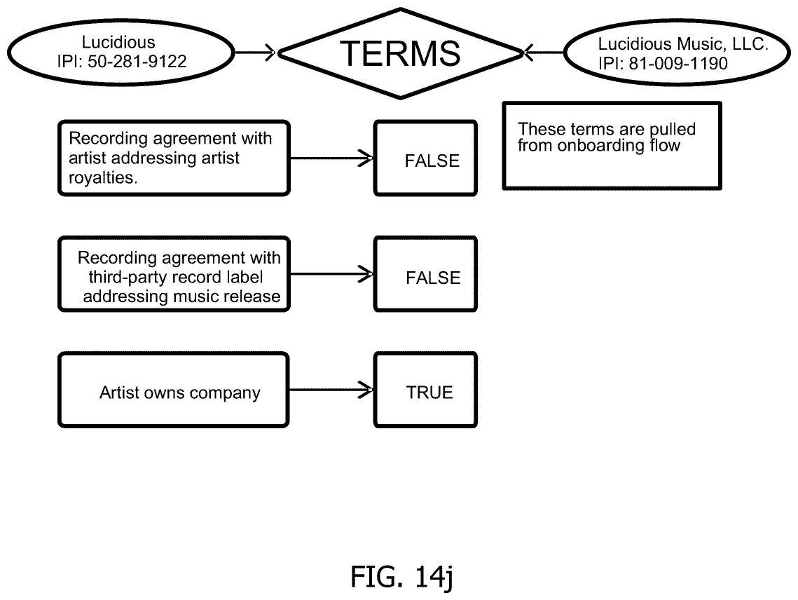

The foregoing examples and embodiments of contract generation devices, onboarding interfaces, methods and process can be further enhanced by the methods, structures and devices of FIGS. 14-22. Notably FIG. 14 and its constituent FIGS. 14a-14h, show the song graph structure that enables many features of many of the inventions described herein.

FIG. 14a is a portion of the song graph shown in FIG. 14. Shown in FIG. 14a are a legend of rectangular category/container structures, oval objects (e.g. individual, company), and diamond/kite shaped data structures. The Song Graph is for an object “Midnight in the 6ix.”

FIG. 14b illustrates the relationship between pre-existing/parent works and Lyric, Sound and Sample take from “Burning the Midnight Oil” a song having both ISWC and ISRC records and a reference/link to the song graph for “Burning the Midnight Oil.”

FIG. 14c is a portion of the song graph shown in FIG. 14 illustrating the relationship between two different Master Recordings the first being the “Original” with its own unique ISRC number and metadata and the other being “Lucid's Version” with its own ISRC and metadata.

FIG. 14d is a portion of the song graph shown in FIG. 14 showing the relationship between the song graph and derivative works referencing a specific work “Midnight in the 6ix” (Burnt Remix) with its own unique ISRC and ISWC numbers and a reference/link to the derivative work's song graph.

FIG. 14e is a portion of the song graph shown in FIG. 14 showing the relationship between the song and its various contributors. In this specific example there is a parent songwriter, host artist, featured artist, songwriter and a producer, song writer and mixing engineer. For each of these relationships there are respective specific entities, e.g. Allen Brown, R3K, Lucidious and Mermaid Money that each have their own IPI and/or other attributes. Song Graphs may vary and there may be more than one songwriter or more than one featured artist, producer, engineer, etc.

FIG. 14f is a portion of the song graph shown in FIG. 14 illustrating the relationship with administrative entities such as loan-out companies (e.g. Ludicious Music, LLC), record labels and third-party distributors.

FIG. 14g is a portion of the song graph shown in FIG. 14 showing the relationship between the song, various entities by agreements expressed in terms and specific document ids between the related parties and counterparties.

FIG. 14h is a portion of the song graph shown in FIG. 14. further showing the relationship between the song, various entities by agreements expressed in terms and specific document ids between the related parties and counterparties.

FIG. 14i is a portion of the song graph shown in FIG. 14. further showing the structure and attributes of terms of the relationship between R3K and Lucidious. Wherein the entities (R3K/Lucidious) are identified by IPI and the contract/agreement has various attributes such as effective date, credit, percentages, guest fee, recoupables, and revisions. Although picture percentages include record royalties, song writing royalties, music video royalties, other royalties and percentages may also be tracked (e.g. product royalties, concert sales, TV Performance, etc). Revisions shows how often the terms have been revised.

FIG. 14j show additional terms which are example of the terms set through the onboarding user interface, e.g. recording agreement with artist addressing royalty, recording agreement with third-party record label addressing music releases, artist owning publishing company. These terms are checked against the user input by the conflict and verification modules.

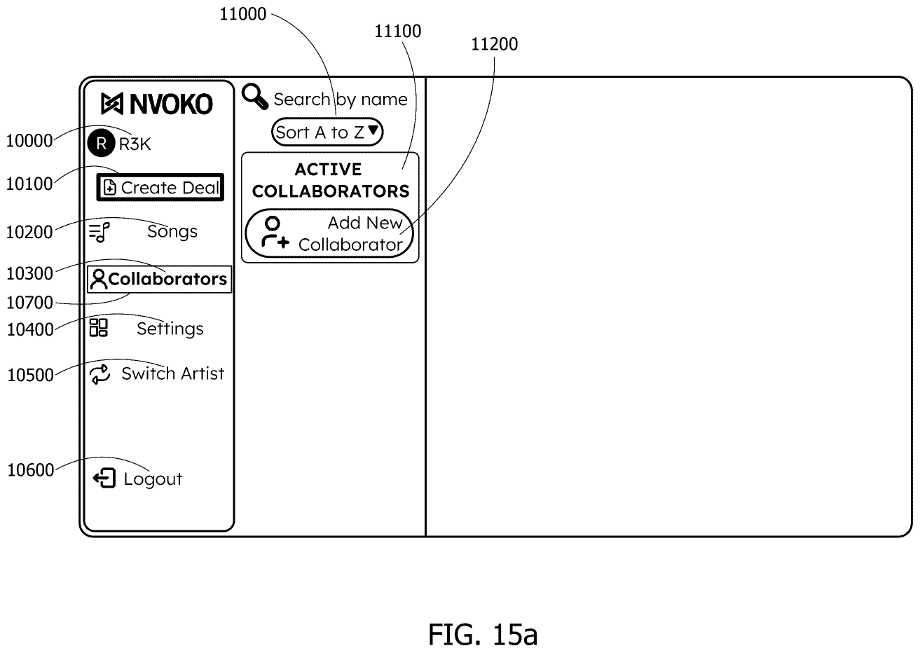

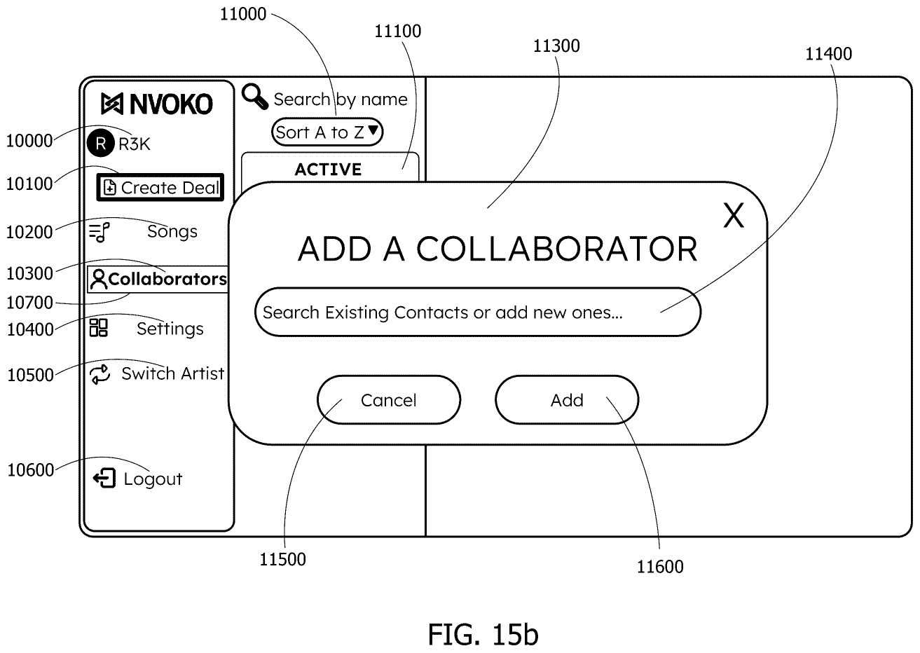

FIG. 15a is a user interface for a collaborator module. Shown and numbered are: User Identification 10000; Create Deal Non-Contextual Primary Button 10100; Songs Menu Selector Button 10200; Collaborators Menu Selector Button 10300; Settings Menu Selector Button 10400; Switch Artist Button 10500; Logout Button 10600; Active Menu Indicator 10700; Collaborator Search Interface and Sorting Selector 11000; Active Collaborators Listing Zone 11100; and, Add Collaborator Button 11200.

FIG. 15b is a user interface for a collaborator module. Shown and numbered are: User Identification 10000; Create Deal Non-Contextual Primary Button 10100; Songs Menu Selector Button 10200; Collaborators Menu Selector Button 10300; Settings Menu Selector Button 10400; Switch Artist Button 10500; Logout Button 10600; Active Menu Indicator 10700; Collaborator Search Interface and Sorting Selector 11000; Active Collaborators Listing Zone 11100; Add Collaborator Popup Interface 11300; Artist Name Input Interface 11400; Cancel Adding Collaborator Button; Confirm Adding Collaborator Button 11600.

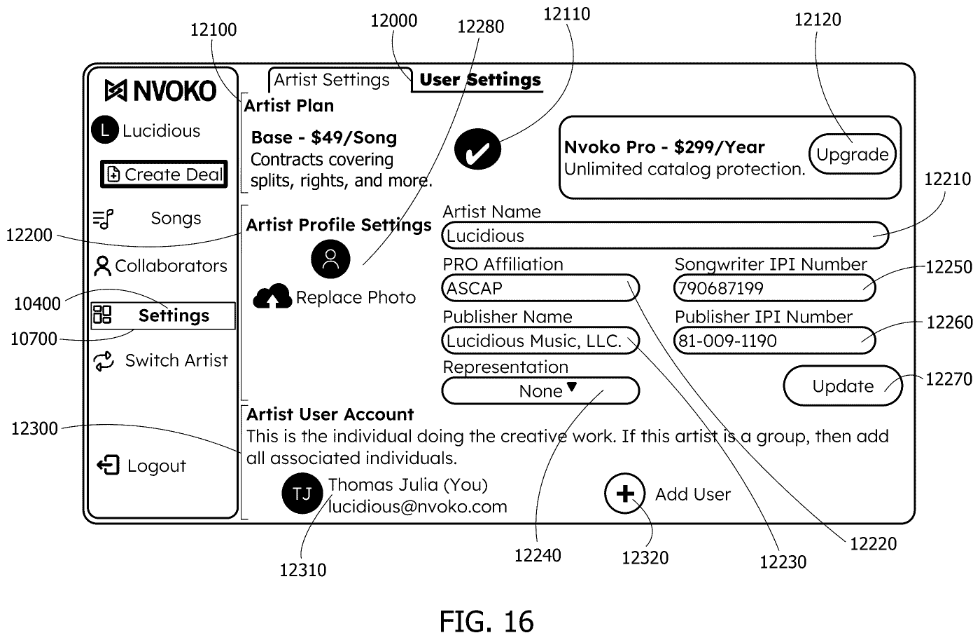

FIG. 16 is a user interface for an artist settings module. Shown and numbered are: Settings Sub Menu Selector 12000; Plan Selector 12100; Active Plan Marker 12110; In App Purchase Interface (Upgrade/Select/Purchase Button) 12120; Artist Profile Engine 12200; Artist Name Input Field 12210; PRO Affiliation Input Field 12220; Publisher Name Input Field 12230; Representation Input Field and Selector 12240; Songwriter IPI Number Input Field 12250; Publisher IPI Number Input Field 12260; Update Artist Profile Settings Button 12270; and, Artist Photo Interface 12280

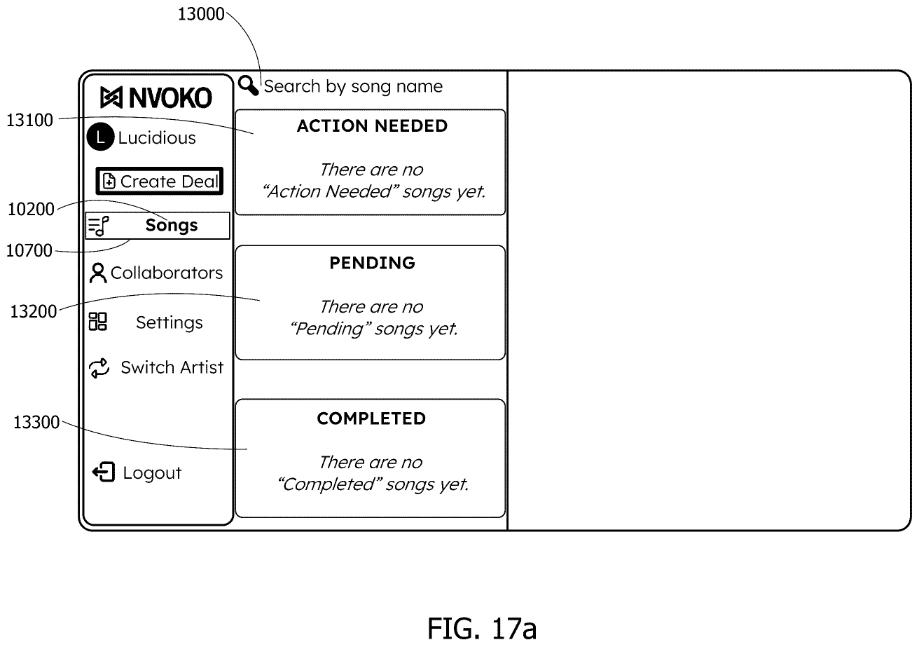

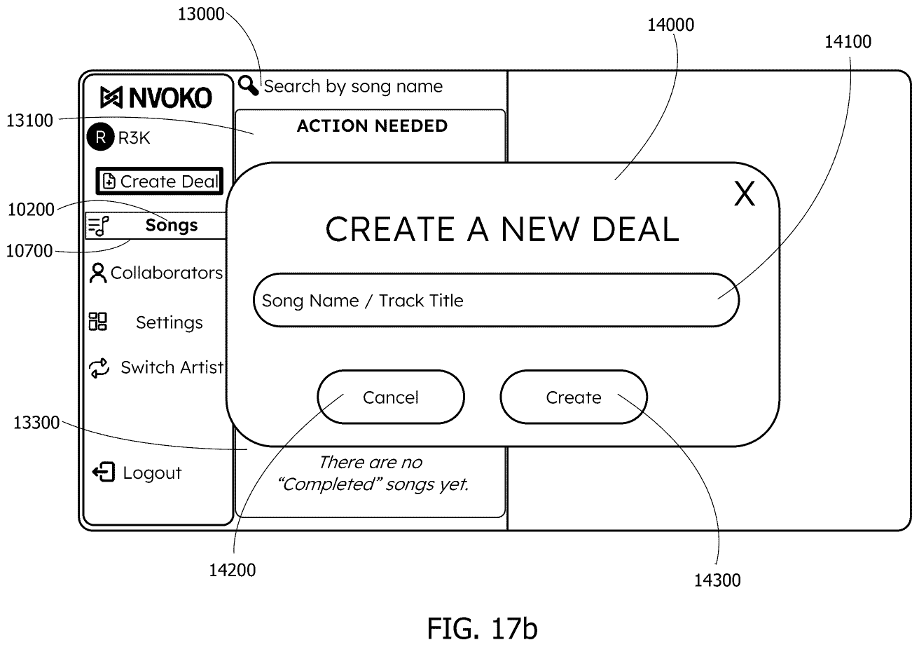

FIG. 17a is a user interface for a song module. Shown and numbered are: Songs Menu Selector Button 10200; Active Menu Indicator 10700; Song Status Search Interface 13000; Action Needed Song Zone 13100; Action Needed Song Status Card 13110; Pending Song Zone 13200; and, Completed Song Zone 13300.

FIG. 17b is a user interface for a create a new deal module. Shown and numbered are: Songs Menu Selector Button 10200; Active Menu Indicator 10700; Song Status Search Interface 13000; Action Needed Song Zone 13100; Completed Song Zone 13300; Create a New Deal Popup Interface 14000; Song Name/Track Title Entry Field for Create a New Deal Popup Interface 14100; and, Cancel Creating a New Deal Button 14200; Confirm Song Name/Track Title for New Deal Button 14300.

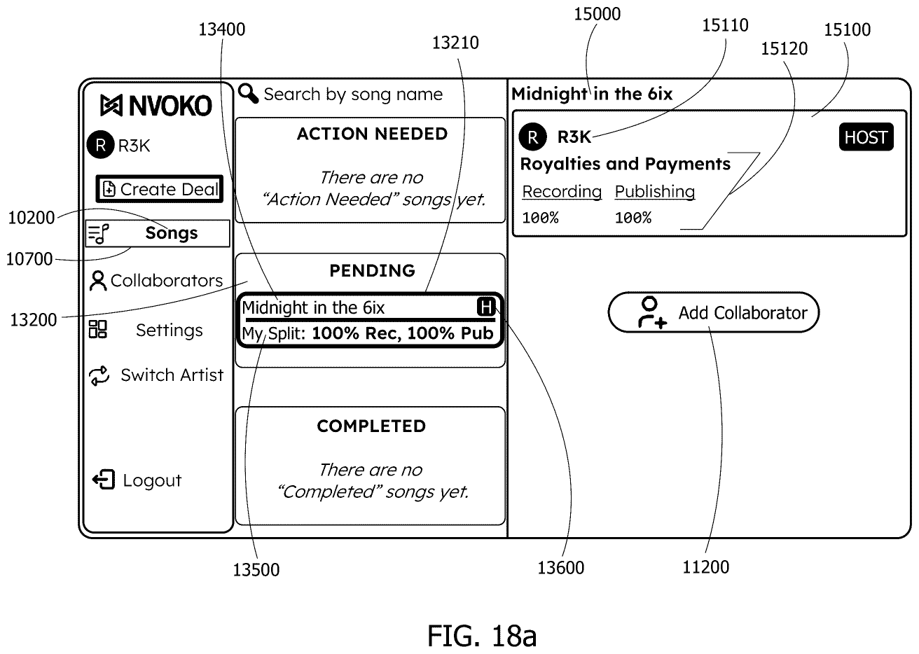

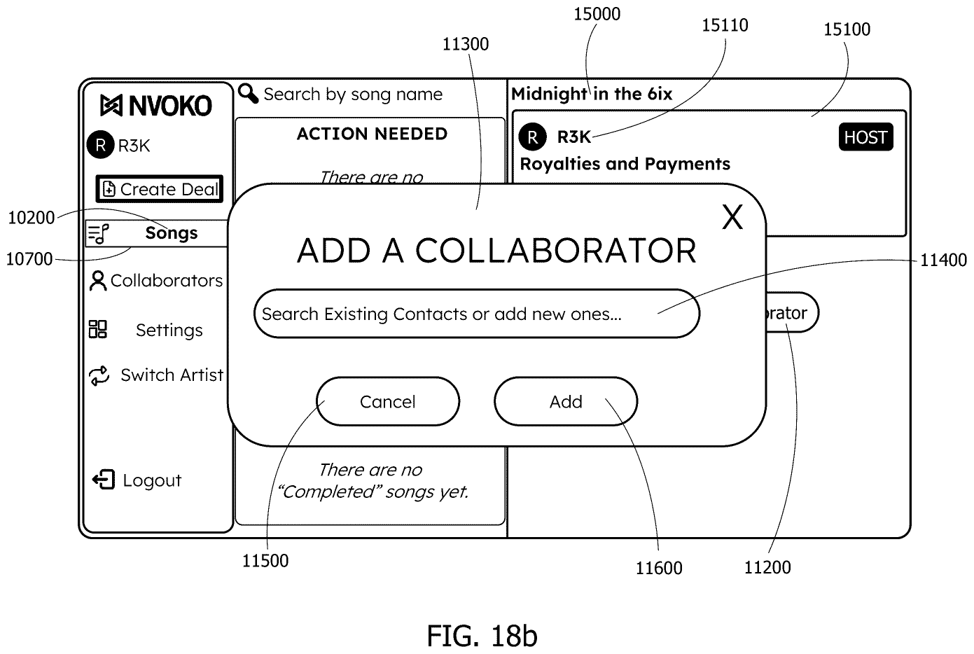

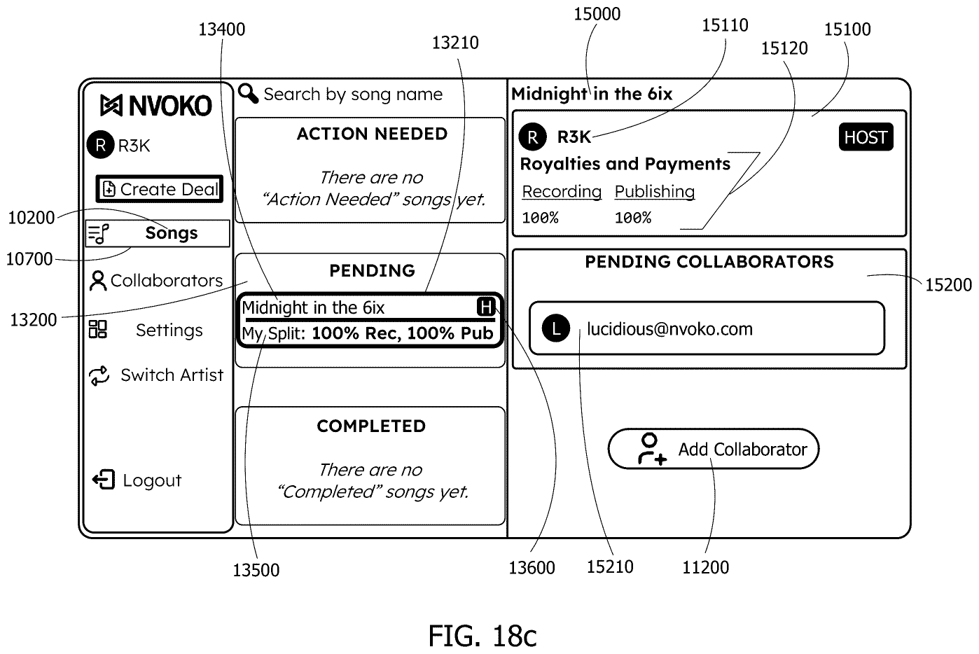

FIG. 18a is a user interface. Shown and numbered are: Songs Menu Selector Button 10200; Active Menu Indicator 10700; Pending Song Zone 13200; Pending Song Status Card 13210; Song Name for Song Status Card 13400; Song Split Summary For Song Status Card 13500; Host Indicator for Song Status Card (as opposed to Guest Indicator) 13600; Selected Song Name 15000; Song Host Card 15100; Host Identification for Selected Song 15110; and, Host Royalties and Payments Summary 15120.

FIG. 18b is a user interface. Shown and numbered are: Songs Menu Selector Button 10200; Active Menu Indicator 10700; Add Collaborator Button 11200; Add Collaborator Popup Interface 11300; Cancel Adding Collaborator Button 11500; Confirm Adding Collaborator Button 11600; Selected Song Name 15000; Song Host Card 15100; and, Host Identification for Selected Song 15110.

FIG. 18c is a user interface. Shown and numbered are: Songs Menu Selector Button 10200; Active Menu Indicator 10700; Pending Song Zone 13200; Pending Song Status Card 13210; Song Name for Song Status Card 13400; Song Split Summary For Song Status Card 13500; Host Indicator for Song Status Card (as opposed to Guest Indicator) 13600; Selected Song Name 15000; Song Host Card 15100; Host Identification for Selected Song 15110; Host Royalties and Payments Summary 15120; Pending Collaborators Zone 15200; and, Pending Collaborator 15210.

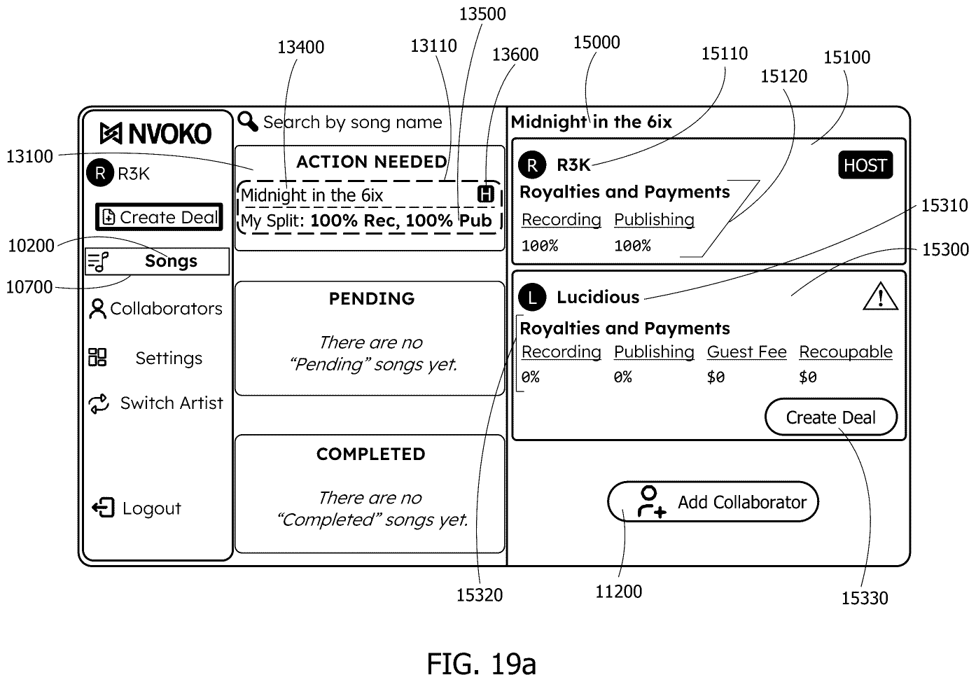

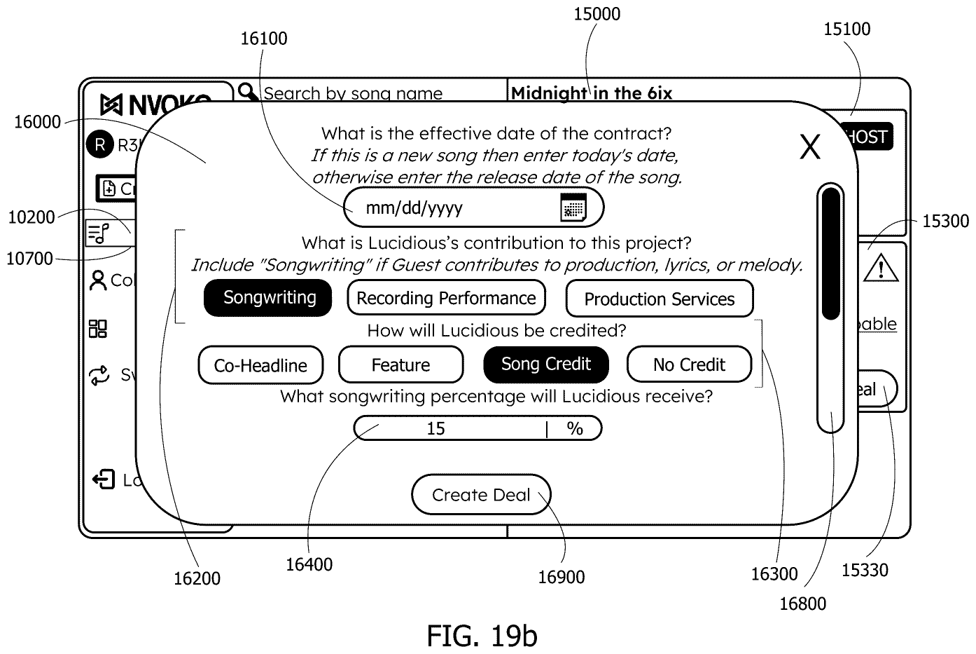

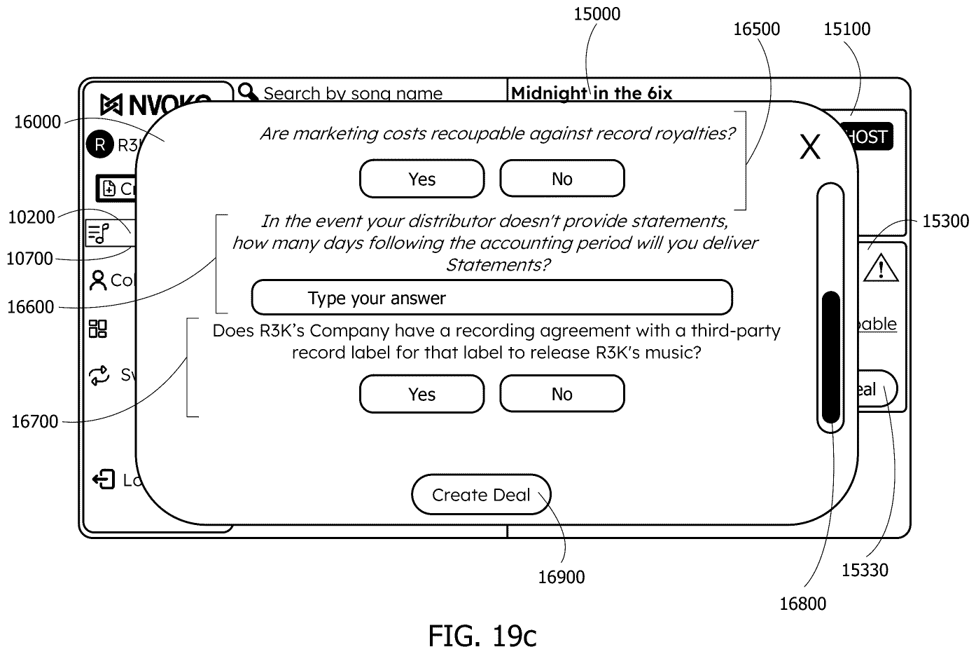

FIG. 19a is a user interface. Shown and numbered are: Songs Menu Selector Button 10200; Active Menu Indicator 10700; Action Needed Song Zone 13100; Action Needed Song Status Card 13110; Song Name for Song Status Card 13400; Song Split Summary For Song Status Card 13500; Host Indicator for Song Status Card (as opposed to Guest Indicator) 13600; Selected Song Name 15000; Song Host Card 15100; Host Identification for Selected Song 15110; Host Royalties and Payments Summary 15120; Active Collaborator Card 15300; Collaborator Identification for Selected Song 15310; Collaborator Royalties and Payments 15320; and, Create Deal Button Contextual to Collaborator Card 15330.

FIG. 19b is a user interface. Shown and numbered are: Songs Menu Selector Button 10200; Active Menu Indicator 10700; Selected Song Name 15000; Song Host Card 15100; Active Collaborator Card 15300; Create Deal Button Contextual to Collaborator Card 15330; Collaborator Contextual Create Deal Popup Interface 16000; Contract Effective Date Entry Field 16100; Contribution Selector 16200; Credit Selector 16300; Songwriting Percentage Entry Field 16400; Scroll Bar for Collaborator Contextual Create Deal Popup Interface 16800; and, Confirm Deal Terms Button for Collaborator Contextual Create Deal Popup Interface 16900.

FIG. 19c is a user interface. Shown and numbered are: Songs Menu Selector Button 10200; Active Menu Indicator 10700; Selected Song Name 15000; Song Host Card 15100; Active Collaborator Card 15300; Create Deal Button Contextual to Collaborator Card 15330; Collaborator Contextual Create Deal Popup Interface 16000; Recoupable Marketing Cost Selector 16500; Day Amount for Statement Delivery Entry Field 16600; Third Party Music Release Selector 16700; Scroll Bar for Collaborator Contextual Create Deal Popup Interface 16800; and, Confirm Deal Terms Button for Collaborator Contextual Create Deal Popup Interface 16900.

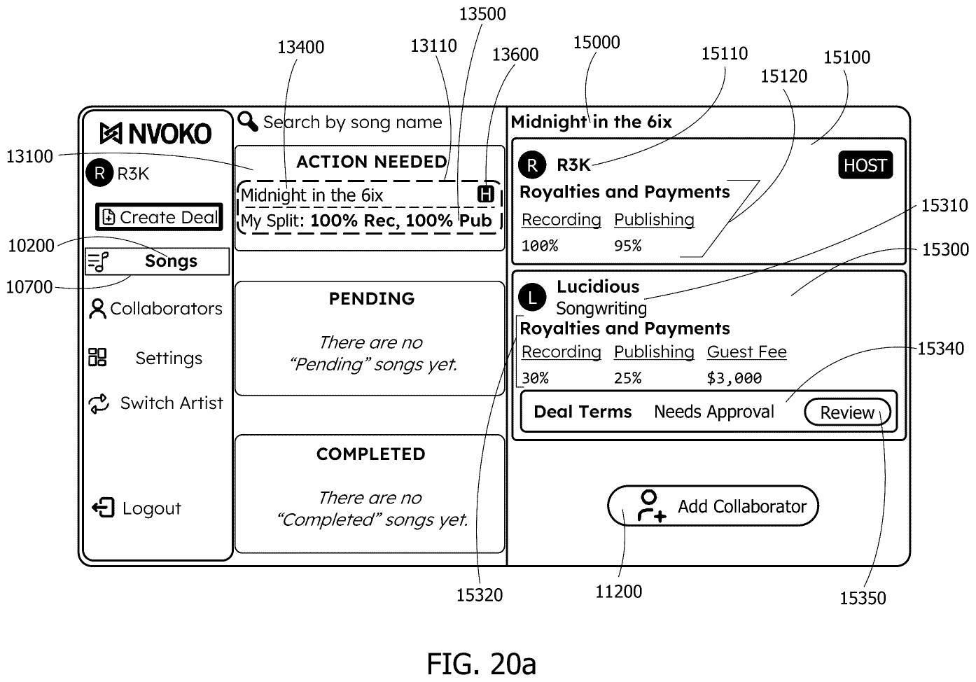

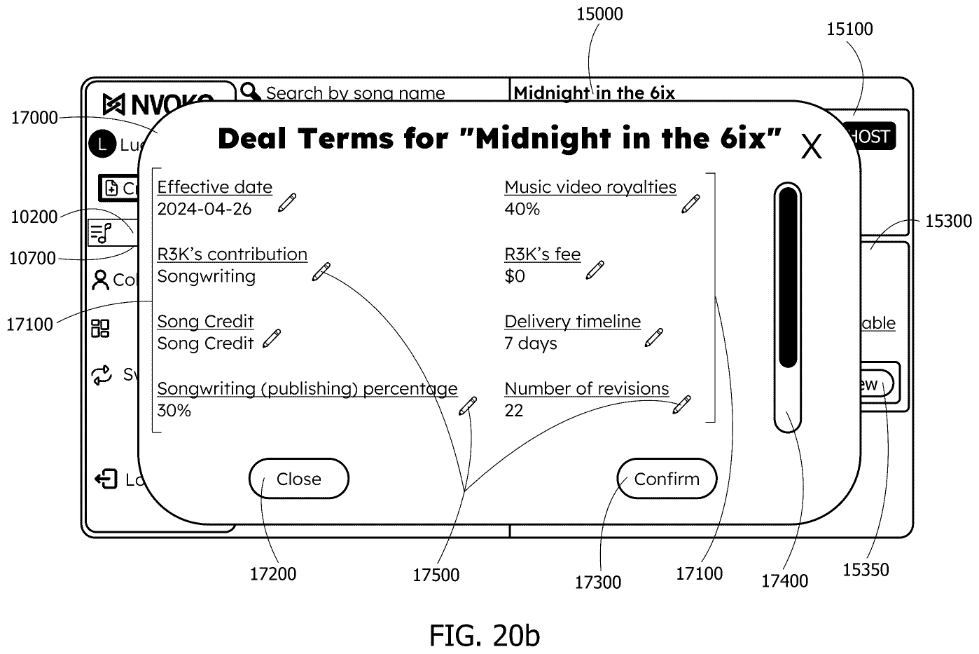

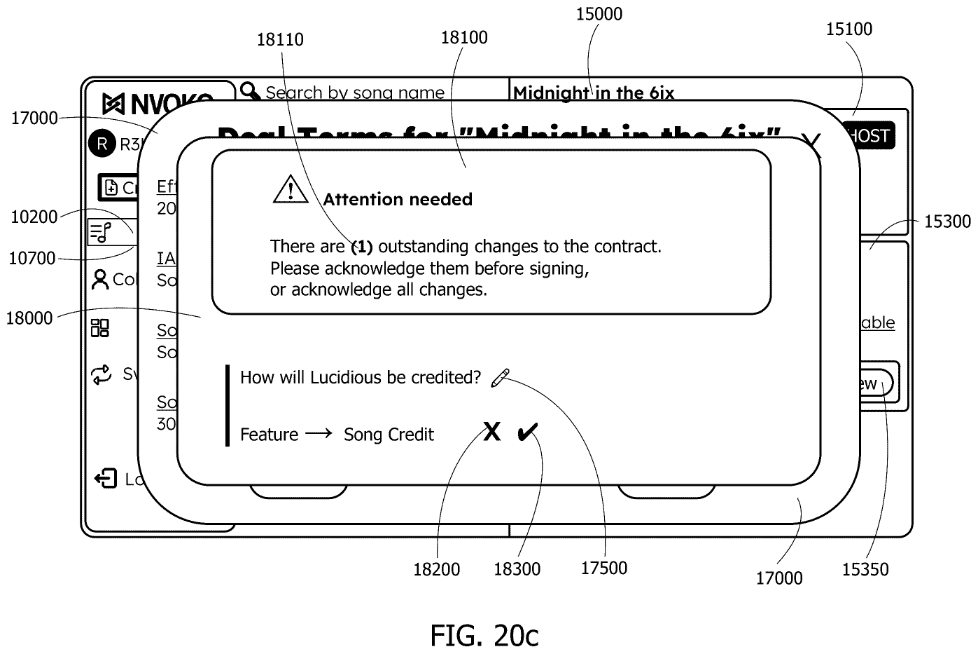

FIG. 20a is a user interface for a song module from the account of R3K. Shown and numbered are: Songs Menu Selector Button 10200; Active Menu Indicator 10700; Action Needed Song Zone 13100; Action Needed Song Status Card 13110; Song Name for Song Status Card 13400; Song Split Summary For Song Status Card 13500; Host Indicator for Song Status Card (as opposed to Guest Indicator) 13600; Selected Song Name 15000; Song Host Card 15100; Host Identification for Selected Song 15110; Host Royalties and Payments Summary 15120; Active Collaborator Card 15300; Collaborator Identification for Selected Song 15310; Deal Terms Review Card 15340; and, Deal Terms Review Button 15350.

FIG. 20b is a user interface. Shown and numbered are: Songs Menu Selector Button 10200; Active Menu Indicator 10700; Selected Song Name 15000; Song Host Card 15100; Active Collaborator Card 15300; Deal Terms Review Button 15350; Deal Terms Popup Interface 17000; Deal Terms Entry Fields 17100; Close Deal Terms Popup Interface Button 17200; Confirm Deal Terms Button for Deal Terms Popup Interface 17300; Scroll Bar for Deal Terms Popup Interface 17400; and, Edit Field Button 17500.

FIG. 20c is a user interface. Shown and numbered are: Songs Menu Selector Button 10200; Active Menu Indicator 10700; Deal Terms Popup Interface 17000; Selected Song Name 15000; Song Host Card 15100; Active Collaborator Card 15300; Deal Terms Review Button 15350; Deal Terms Popup Interface 17000; Edit Field Button 17500; Contract Change Confirmation Popup Interface 18000; Reject Contract Changes Button 18200; and, Accept Contract Changes Button 18300.

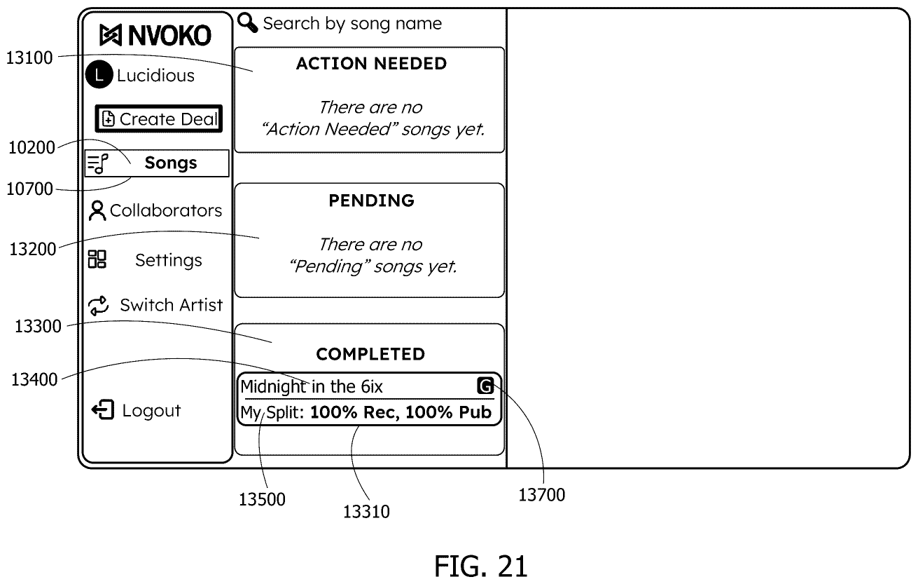

FIG. 21 is user interface. Shown and numbered are: Songs Menu Selector Button 10200; Active Menu Indicator 10700; Pending Song Zone 13200; Completed Song Zone 13300; Completed Song Status Card 13310; Song Name for Song Status Card 13400; Song Split Summary For Song Status Card 13500; and, Guest Indicator for Song Status Card (as opposed to Host Indicator) 13700.

The user interfaces also represent API elements, and inputs and outputs for biological (e.g. human, animal, plant, fungi, living thing), programmed and machine to machine technologies. Such inputs and outputs being compatible with a wide range of organic and in-organic use cases, including but not limited to a variety of sensors, displays and records. For example, a user could be more rapidly onboarded by feeding the onboarding data from trusted or partially trusted packages/feeds/sources provided through biometrics, social media accounts, certificate holders, rfid, nfc device, paired Bluetooth or other trusted authorities.

Moreover, the song graph structure herein describe is adaptable and can be used for other purposes by substituting the song for other collaborative works such as films, movies, immersive media, works of visual art, audiovisual works, marks, objects, rights, restrictions, assets, liabilities, attributes and processes.

The Song Graph is used amongst other things to represent song ownership and rights structure. A special processor processes and generates song graphs or does so through instructions operating on data sources. Generally, a song graph exists as a graph, each entity being a node, and the relationship as a node attribute:

### Example Nodes and Relationships:

Master Song→Interested Parties
   IPI #1→Artist
      Name: John S.
      Relationship to Contract: Host
      Payment: 70% Recording, 80% Publishing, 7300 Guest Fee
      (Paid Prospectively)
      Signed: 2024-01-01
   Company ABC
      Relationship: Label
   IPI #2—Producer
      Name: Jane K.
      Relationship to Contract: Guest
      Payment: 30% Recording, 20% Publishing, $300 Guest
      Fee (Paid usProspectively)
      Signed: 2024-01-01
   Company XYZ
      Relationship: Loan-Out
   Master Song
      Companies
      International Standard Recording Codes
   Master Recording (Self)
      Sample
      This can have its own sub-set of nodes
      International Standard Musical Work Codes
      (Self Reference) Master Composition

A graph can be incomplete (for example, only include IPIs with royalty information)

Partial or complete graphs can be overlaid with one another to identify conflicts and build a more comprehensive analysis.

The system enables interconnection with outside data providers and provides the mechanisms and song graphs to compare its data with that of the system and the data of other providers. Data is pulled or pushed, and connected when applicable with UJPCs, ISRCs, ISWCs, IPIs, release names, artist names, and other connected databases. Notably the platform compares outside data with its processed contract information and information obtained from other providers and identifies any conflicts or missing information. The platform then alerts, notifies, and sends the parties notice of the conflict and possible remedies. By constantly improving the data the platform is offers, certifies, and guarantees quantifiable and qualitative levels of trust.

The contract renderer performs several steps:
1. (jets contract template from library
2. Gets data from Question Answers, Artist Settings, and Company Settings
3. Builds a Deal Scope, wherein the deal scope encompasses all variables and
deduced parameters
4. Evaluates (and potentially modify) each node in the contract template
   4.1 Conditional visibility
   4.2 Variable placeholders
5. Renders the content of the contract node into a DOM node with the given tag name and attributes
6. Provides or saves the rendered contract

The system also provides a transformer engine. The transformer engine converts existing agreements into song graphs, by automatically referencing and understanding the impact of pre-existing works and enables bundles of contracts associated with a party to be referenced and enables existing party to be referenced in new deals and for the party to inherit rights from other contracts for incorporation in additional agreements and commercial projects.

The system is particularly useful when using multiple song graphs for a discography that is able to show a complete rights coverage for a discography or other catalog or collection of works.

The system also has mechanisms to promote trust and efficiency in negotiations. For instance, specific acknowledgement is required in that before a user can sign a contract the user must acknowledge all changes made by any other party since the last time the user reviewed the deal. Furthermore, history is provided that allows the user to see changes the user and/or other parties to a deal have made and how they have evolved over time. Also, a specific user interface and API are provided to enable users to converse regarding specific deal terms, much like comments in a word processing document. However, the user has the benefit of the complete song graph structure and access to the existing entities are relationships for verification and suggestion of autocomplete/computer aided/AI responses.

Thus, inputs for the platform often are the result of questions automatically or manually answered by/with multiple sources such as:
Third-party data (like copyright offices)
Incorporating data based on pre-existing works
Computed Answers based on Decision Trees
User Onboarding (FIG. 5 and related Figures)
User profile information
Company information and associations to users (is this an individual, a label company, a loan-out company, etc.)

Furthermore, the system provides the mechanism to automatically integrate additional data into existing song graph structures without necessitating a complete reconfiguration of the graph. The system includes an update mechanism that allows for the seamless integration of new data into existing Song Graph structures. This feature is critical for maintaining the accuracy and relevance of the Song Graph without requiring a complete reconfiguration each time new data is added. As the source of truth for legal agreements and data, this ensures the system remains up-to-date and reliable.

### For Instance:

1) FIG. 14a: the Song Graph depicts various entities and their relationships. When new data, such as additional rights information or new collaborators, is added, it is integrated into the existing graph structure seamlessly.
2) FIG. 14d: Shows how derivative works like “Midnight in the 6ix (Burnt Remix)” are incorporated into the Song Graph, demonstrating the system's ability to handle new data without reconfiguring the entire graph.
3) FIG. 20b: Shows recent Song Graph changes and required approvals before changes to the Song Graph are finalized. This ensures that any new data added to the graph is verified and approved by relevant stakeholders before the enforcing contract can be generated by the Contract Renderer Unit (FIG. 13).

By way of example, when a new songwriter is added to an existing collaboration, their details and roles are integrated into the Song Graph without disrupting the current graph. For instance, if a new contributor is added to a song, nodes and edges representing them and any relevant company associations and contractual agreements are added to the graph, ensuring the data is up-to-date.

The system is also configured to alert users to changes in one or more song graphs due updates in data including but not limited to song attributes, entities, and relationships. The notification module ensures that users are promptly informed about any changes in the Song Graph, including updates to song attributes, addition of new entities, changes in relationships between entities, and alterations in the Terms graphs. As the system is the source of truth for legal agreements and the platform for generating these agreements, any updates or discrepancies in the legal data are critical and must be communicated to the relevant stakeholders immediately. Moreover, these changes to the Song Graph must be approved before rendering the contract through the Contract Generation Device. For instance:
FIG. 14g: With agreements between entities, if a contract is amended or new legal terms are added, the notification module alerts all relevant parties.
FIG. 14i: If there are changes in the agreed percentages, such as royalty splits or contractual terms, the notification module notifies the affected parties.
FIG. 15a: There is a user interface showing active collaborators, if a new collaborator is added or an existing one is removed, the notification module updates all stakeholders.
FIG. 15b: There is a user interface for adding collaborators, changes her trigger notifications to relevant parties that are related by the respective Song Graph.
Approval Process: Changes to the Song Graph must be approved by relevant stakeholders before they are finalized. This can be seen in FIG. 17a, where the user interface indicates pending actions and approvals required.

A data validation module configured to assess the completeness and accuracy of the data being represented in the graph, said data validation module further configured to prompt users for verification or additional data when necessary to ensure the reliability of the graph representation. The data validation module plays a meaningful role in maintaining the integrity and reliability of the Song Graph. It assesses the completeness and accuracy of the data represented in the graph. If it detects any missing or potentially inaccurate data, it prompts users to verify or provide additional information. For instance:
With regards to Contributors: FIG. 14e shows various contributors and their roles (e.g., Lucidious as a featured artist, Mermaid Money as a producer, etc.). The data validation module ensures that all necessary details about these contributors are accurate. If the system detects missing information (e.g., missing IPI numbers or roles), it prompts the user to fill in the gaps.
With regards to Administrative Entities: FIG. 14f illustrates the administrative entities managing different aspects of the music rights. The data validation module checks the completeness of the information related to these entities. For instance, if an entity is listed without a corresponding IPI number or agreement, the system prompts the user to provide the missing details. More specifically, suppose the data validation module detects that Lucidious Music, LLC, listed in FIG. 14f, does not have a corresponding agreement document ID. The module then prompts the user to provide this information to ensure the graph's accuracy.

There is also a conflict analysis module. The conflict analysis module operates by iterating through the nodes and edges of different song graphs to identify potential conflicts and additions. It overlays the graphs and performs a differential analysis to detect overlapping, contradictory data, and new data that needs to be added. The result is a new sub-graph that highlights conflicts and additions.

A sub-graph is a smaller part of the complete Song Graph, containing only some of the nodes (entities) and edges (relationships) that are present in the original graph.

Example Scenario: Sub-Graph of Conflicts between two Song Graphs Example Scenario: Sub-Graph of Additions to existing Song Graphs Example Scenario: Provider with Partial Data

A more detailed implementation of the conflict analysis module is explained below, by the following scenarios:

### Graph Representation:

Each Song Graph is represented as a directed graph (G=(V, E)), where (V) is the set of nodes (entities related to musical works) and (E) is the set of edges (relationships between the entities).

### Overlaying Graphs:

To overlay two graphs (G_1=(V_1, E_1)) and (G_2=(V_2, E_2)), the module creates a combined graph (G_c=(V_c, E_c)), where (V_c=V_1\cup V_2) and (E_c=E_1\cup E_2).

### Differential Analysis:

The module iterates through each node (v) in (V_c) and each edge(e) in (E_c) to identify overlaps, conflicts, and additions.
For nodes (v\in V_1 cap\V_2):
   Compare attributes of (v) from both graphs. If attributes conflict (e.g., different royalty percentages), the module flags this node.
For nodes (v\in V_1\setminus V_2) or (v\in V_2\setminus V_1):
   Flag these nodes as additions.
For edges (e=(v_i, v_j)\in E_1\cap E_2):
   Compare attributes of (e) from both graphs. If attributes conflict (e.g., different contractual obligations), the module flags this edge,
For edges (e\in E_1\setmninus E_2) or (e\in E_2\setminus E_1):
   Flag these edges as additions.

### Creating Sub-Graphs of Conflicts and Additions:

The module constructs two sub-graphs:
(G_{conflicts}=(V_{conflicts}, E_{conflicts})), where (V_{conflicts}) and (E_{conflicts}) are the sets of nodes and edges that have been flagged as conflicts.
(G_{additions}=(V_{additions}, E_{additions})), where (V_{additions}) and (E_{additions}) are the sets of nodes and edges that have been flagged as additions,

### Example Scenario Referring to FIG. 14a:

1. Consider two graphs representing “Midnight in the 6ix” from two different Performing Rights Organizations. The module overlays these graphs.
2. Node Conflict: If both graphs have a node for “Lucidious” with conflicting publishing percentages, this node is flagged and included in (V_{conflicts}).
3. Node Addition: If the graph for “Midnight in the 6ix” includes a new contributor “Mermaid Money” not present in the other graph, this node is flagged and included in (V_{additions}).
4. Edge Conflict: If both graphs have an edge representing a relationship between “R3K” and “Mermaid Money” but with different contractual obligations, this edge is flagged and included in (E_{conflicts})
5. Edge Addition: If the graph for “Midnight in the 6ix (Burnt Remix)” includes a new relationship (edge) between “R3K” and a new contributor “Mermaid Money,” this edge is flagged and included in (E {additions}).

1. A system for managing music rights comprising:
an interface module configured to accept one or more song attributes regarding one or more musical works,
a data storage module configured to store one or more song attributes regarding the one or more musical works:
a song graph module configured to generate one or more song graphs of the one or more musical works, wherein:
one or more entities related to the musical works are represented as one or more nodes within a song graph;
relationships between the one or more entities are represented as edges between the nodes of the song graph, wherein attributes of each relationship are stored as edge attributes within the song graph;
a display module configured to display one or more song attributes of the one or more song graphs.

2. The system of claim 1 further comprising
a filtering module configured to selectively include or exclude nodes and edges from the one or more song graphs based on predefined criteria such as the presence of royalty information, specific contractual roles, or other relevant attributes.

3. The system of claim 1 further comprising
an update mechanism configured to automatically integrate additional data into existing graph structures without necessitating a complete reconfiguration of the graph.

4. The system of claim 1 further comprising
a notification module configured to alert users to changes in one or more song graphs due updates in data including but not limited to song attributes, entities and relationships.

5. The system of claim 1 further comprising
a data validation module configured to assess the completeness and accuracy of the data being represented in the graph, said data validation module further configured to prompt users for verification or additional data when necessary to ensure the reliability of the graph representation.

6. The system of claim 1 further comprising a conflict analysis module, said conflict analysis module configured to:
overlay partial or complete graph representations of different sets of music rights and ownership data;
automatically identify potential conflicts in music rights and ownership from overlapping nodes and edges within the combined graph representations;
provide notice of one or more conflicts, including:
overlapping claims to royalties;
contradictory recording rights;
contradictory publishing rights; and,
discrepancies in contractual obligations between entities represented within the graph.

7. The system of claim 6 wherein said conflict analysis module is further configured to:
prioritize conflicts based on the severity and impact of the conflict on one or more interested parties.

8. The system of claim 7 further comprising:
a resolution module configured to offer one or more of the following resolution strategies:
suggesting possible amendments to agreements;
reallocation of rights; and,
remedial action to resolve identified conflicts.

9. The system of claim 8 further comprising a user interface that enables users to simulate various resolution scenarios within the graph to evaluate the outcomes and effectiveness of different conflict resolution strategies.

10. The system of claim 9 further comprising a historical resolution module configured to integrate historical data and precedents in music rights management to aid in the resolution process, thereby providing users with evidence-based recommendations for conflict resolution.

11. The system of claim 10 further comprising a user interface that shares conflict analyses and resolution proposals securely, ensuring that all parties are informed and can participate in the resolution process.

12. A device for managing music rights comprising:
one or more interfaces configured to accept onboarding information;
a data storage module configured to store the onboarding information;
a non-transitory computer readable medium instructing said microprocessor to perform the following steps:
store one or more nodes associated with entities derived from the onboarding information related to one or more musical works; and,
store one or more relationships between the one or more entities are stored as edges between the nodes wherein one or more attributes of the one or more relationships are edge attributes; and,
a display module configure to display the onboarding information by accessing the nodes associated with one or more musical works.

13. The device of claim 10 further comprising: a module that determines based on the onboarding information, a deal scope for the first user and the second user; and, a contract rendering module that renders a draft contract for the first user and the second user based on the deal scope.

14. The device of claim 13 wherein the deal scope is determined at least in part based on a pre-existing contractual relationship between the first user and the second user.

15. The device of claim 13 wherein the deal scope is determined at least in part based on a pre-existing relationship between the first user and a third-party company not associated with the contract.

16. The device of claim 13 further comprising a contract rendering module that displays the contract.

17. A method of managing music rights comprising:
using an interface module to accept onboarding information including information about one or more musical works;
storing the onboarding information;
using a song graph module configured to generate one or more song graphs of the one or more musical works, wherein:
one or more entities related to the musical works are represented as one or more nodes within a song graph;
relationships between the one or more entities are represented as edges between the nodes of the song graph, wherein attributes of each relationship are stored as edge attributes within the song graph.

18. The method of claim 16 further comprising a display module configured to display one or more song attributes of the one or more song graphs.

19. The method of claim 16 wherein the interface module is a user interface module providing input means for at least one or more of the following attributes:
Artist name; PRO affiliation; Songwriter IPI; Publisher IPI; and, Representation.

20. The method of claim 16 wherein the interface module is an application programing interface module providing input means for:
Artist name; PRO affiliation; Songwriter IPI; Publisher IPI; and, Representation.
